(19) United States
(12) Patent Application Publication
(10) Pub. No.: US 2016/0356140 A1
(43) Pub. Date: Dec. 8, 2016

(54) Lithological displacement of an evaporite mineral stratum

(71) Applicant: SOLVAY SA, Brussels (BE)

(72) Inventors: Ronald O. HUGHES, Green River, WY (US); Matteo PAPERINI, Green River, WY (US); Herve CUCHE, Waterloo (BE); Joseph A. VENDETTI, Green River, WY (US); Larry REFSDAL, Green River, WY (US); Jean-Paul DETOURNAY, Floreffe (BE); David HANSEN, Green River, WY (US); Todd BRICHACEK, Green River, WY (US); Justin T. PATTERSON, Mountain View, WY (US); John KOLESAR, Green River, WY (US); Ryan SCHMIDT, Green River, WY (US); Beatrice C. ORTEGO, Katy, TX (US)

(73) Assignee: SOLVAY SA, Brussels (BE)

(21) Appl. No.: 14/062,878

(22) Filed: Oct. 24, 2013

Related U.S. Application Data
(60) Provisional application No. 61/718,214, filed on Oct. 25, 2012.

(51) Int. Cl. E21B 43/28; C01D 7/00; C01D 7/14; C01D 1/04; C01D 5/14

(52) U.S. Cl. CPC E21B 43/28; C01D 1/04; C01D 5/14; C01D 7/14; C01D 7/00

(57) ABSTRACT

A lithological displacement of an underground evaporite mineral stratum from an underlying non-evaporite stratum comprising the application of a lifting hydraulic pressure of a fluid at a weak interface between the strata, resulting in lifting the overburden above the interface, separating the evaporite stratum from the underlying non-evaporite stratum and thus forming a mineral free-surface. The lifting hydraulic pressure is greater than the overburden pressure. The formed mineral free-surface is accessible for dissolution by a solvent. The fluid used for lifting may comprise a solvent suitable to dissolve the mineral. The evaporite mineral stratum preferably comprises trona, nahcolite, wegscheiderite, or combinations thereof.

### CROSS-REFERENCE TO RELATED APPLICATIONS

The present application claims priority benefit to U.S. provisional application No. 61/718,214 filed on Oct. 25, 2012, this application being herein incorporated by reference in its entirety.

### STATEMENT REGARDING FEDERALLY SPONSORED RESEARCH OR DEVELOPMENT

Not applicable.

### TECHNICAL FIELD OF THE INVENTION

The present invention relates to a method for the lithological displacement of an underground evaporite mineral stratum from an underlying non-evaporite stratum with application of a lifting hydraulic pressure via a fluid injection at the strata interface. The present invention also relates to in situ solution mining of the lithologically-displaced evaporite mineral stratum, in which the injected fluid comprises a suitable solvent for mineral dissolution.

### BACKGROUND OF THE INVENTION

Sodium carbonate (Na₂CO₃), or soda ash, is one of the largest volume alkali commodities made world wide with a total production in 2008 of 48 million tons. Sodium carbonate finds major use in the glass, chemicals, detergents, paper industries, and also in the sodium bicarbonate production industry. The main processes for sodium carbonate production are the Solvay ammonia synthetic process, the ammonium chloride process, and the trona-based processes.

Trona-based soda ash is obtained from trona ore deposits in the U.S. (southwestern Wyoming in Green River, in California near Searles Lake and Owens Lake), Turkey, China, and Kenya (at Lake Magadi) by underground mechanical mining techniques, by solution mining, or lake waters processing.

Crude trona is a mineral that may contain up to 99% sodium sesquicarbonate (generally about 70-99%). Sodium sesquicarbonate is a sodium carbonate-sodium bicarbonate double salt having the formula (Na₂CO₃.NaHCO₃.2H₂O) and which contains 46.90 wt. % Na₂CO₃, 37.17 wt. % NaHCO₃ and 15.93 wt. % H₂O. Crude trona also contains, in lesser amounts, sodium chloride (NaCl), sodium sulfate (Na₂SO₄), organic matter, and insolubles such as clay and shales. A typical analysis of the trona ore mined in Green River is shown in TABLE 1.

TABLE 1

| Constituent | Weight Percent |
|---|---|
| Na₂CO₃ | 43.2-45 |
| NaHCO₃ | 33.7-36 |
| H₂O (crystalline and free moisture) | 15.3-15.6 |
| NaCl | 0.004-0.1 |
| Na₂SO₄ | 0.005-0.01 |
| Insolubles | 3.6-7.3 |

Other naturally-occurring sodium (bi)carbonate minerals from which sodium carbonate and/or bicarbonate may be produced are known as nahcolite, a mineral which contains mainly sodium bicarbonate and is essentially free of sodium carbonate and known as “wegscheiderite” (also called “decemite”) of formula: Na₂CO₃.3NaHCO₃.

In the United States, trona and nahcolite are the principle source minerals for the sodium bicarbonate industry. While sodium bicarbonate can be produced by water dissolution and carbonation of mechanically mined trona ore or of soda ash produced from trona ore, sodium bicarbonate can be produced also by solution mining of nahcolite. The production of sodium bicarbonate typically includes cooling crystallization or a combination of cooling and evaporative crystallization.

The large deposits of mineral trona in the Green River Basin in southwestern Wyoming have been mechanically mined since the late 1940's and have been exploited by five separate mining operations over the intervening period. In 2007, trona-based sodium carbonate from Wyoming comprised about 90% of the total U.S. soda ash production. To recover valuable alkali products, the so-called ‘monohydrate’ commercial process is frequently used to produce soda ash from trona. When the trona is mechanically mined, crushed trona ore is calcined (i.e., heated) to convert sodium bicarbonate into sodium carbonate, drive off water of crystallization and form crude soda ash. The crude soda ash is then dissolved in water and the insoluble material is separated from the resulting solution. A clear solution of sodium carbonate is fed to a monohydrate crystallizer, e.g., a high temperature evaporator system generally having one or more effects (sometimes called ‘evaporator-crystallizer’), where some of the water is evaporated and some of the sodium carbonate forms into sodium carbonate monohydrate crystals (Na₂CO₃.H₂O). The sodium carbonate monohydrate crystals are removed from the mother liquor and then dried to convert the crystals to dense soda ash. Most of the mother liquor is recycled back to the evaporator system for additional processing into sodium carbonate monohydrate crystals.

The Wyoming trona deposits are evaporites and hence form various substantially horizontal layers (or beds). The major deposits consists of 25 near horizontal beds varying from 4 feet (1.2 m) to about 36 feet (11 m) in thickness and separated by layers of shales. Depths range from 400 ft (120 m) to 3,300 ft (1,000 m). These deposits contain from about 88% to 95% sesquicarbonate, with the impurities being mainly dolomite and calcite-rich shales and shortite. Some regions of the basin contain soluble impurities, most notably halite (NaCl). These extend for about 1,000 square miles (about 2,600 km²), and it is estimated that they contain over 75 billions tons of soda ash equivalent, thus providing reserves adequate for reasonably foreseeable future needs.

In particular, a main trona bed (No. 17) in the Green River Basin, averaging a thickness of about 8 feet (2.4 m) to about 11 feet (3.3 m) is located from approximately 1,200 feet (about 365 m) to approximately 1,600 feet (about 488 m) below ground surface. Presently, trona from the Wyoming deposits is economically recovered mainly from the main trona bed no. 17. This main bed is located below substantially horizontal layers of sandstones, siltstones and mainly unconsolidated shales. In particular, within about 400 feet (about 122 m) above the main trona bed are layers of mainly weak, laminated green-grey shales and oil shale, interbedded with bands of trona from about 4 feet (about 1.2 m) to about 5 feet thick (about 1.5 m). Immediately below the main trona bed lie substantially horizontal layers of somewhat plastic oil shale, also interbedded with bands of trona. Both overlying and underlying shale layers contain methane gas.

The comparative tensile strengths, in pounds per square inch (psi) or kilopascals (kPa), of trona and shale in average values are substantially as follows:
Shale: 70-140 psi (482-965 kPa)
Trona: 290-560 psi (2,000-3,861 kPa)

Both the immediately overlying shale layer and the immediately underlying shale layer are substantially weaker than the main trona bed. Recovery of the main trona bed, accordingly, essentially comprises removing the only strong layer within its immediate vicinity.

Most mechanical mining operations to extract trona ore practice some form of underground ore extraction using techniques adapted from the coal and potash mining industries. A variety of different systems and mechanical mining techniques (such as longwall mining, shortwall mining, room-and-pillar mining, or various combinations) exist. Although any of these various mining techniques may be employed to mine trona ore, when a mechanical mining technique is used, nowadays it is preferably longwall mining.

All mechanical mining techniques require miners and heavy machinery to be underground to dig out and convey the ore to the surface, including sinking shafts of about 800-2,000 feet (about 240-610 meters) in depth. The cost of the mechanical mining methods for trona is high, representing as much as 40 percent of the production costs for soda ash. Furthermore, recovering trona by these methods becomes more difficult as the thickest beds (more readily accessible reserves) of trona deposits with a high quality (less contaminants) were exploited first and are now being depleted. Thus the production of sodium carbonate using the combination of mechanical mining techniques followed by the monohydrate process is becoming more expensive, as the higher quality trona deposits become depleted and labor and energy costs increase. Furthermore, development of new reserves is expensive, requiring a capital investment of as much as hundreds of million dollars to sink new mining shafts and to install related mining and safety (ventilation) equipment.

Additionally, because some shale is also removed during mechanical mining, this extracted shale must be transported along with the trona ore to the surface refinery, removed from the product stream, and transported back into the mine, or a surface waste pond. These insoluble contaminants not only cost a great deal of money to mine, remove, and handle, they provide very little value back to the mine and refinery operator. Additionally, the crude trona is normally purified to remove or reduce impurities, primarily shale and other nonsoluble materials, before its valuable sodium content can be sold commercially as: soda ash (Na₂CO₃), sodium bicarbonate (NaHCO₃), caustic soda (NaOH), sodium sesquicarbonate (Na₂CO₃.NaHCO₃.2H₂O), a sodium phosphate (Na₅P₃O₁₀) or other sodium-containing chemicals.

Recognizing the economic and physical limitations of underground mechanical mining techniques, solution mining of trona has been long touted as an attractive alternative with the first patent U.S. Pat. No. 2,388,009 entitled “Solution Mining of Trona” issued to Pike in 1945. Pike discloses a method of producing soda ash from underground trona deposits in Wyoming by injecting a heated brine containing substantially more carbonate than bicarbonate which is unsaturated with respect to the trona, withdrawing the solution from the formation, removing organic matter from the solution with an adsorbent, separating the solution from the adsorbent, crystallizing, and recovering sodium sesquicarbonate from the solution, calcining the sesquicarbonate to produce soda ash, and re-injecting the mother liquor from the crystallizing step into the formation.

In its simplest form, solution mining of trona is carried out by contacting trona ore with a solvent such as water or an aqueous solution to dissolve the ore and form a liquor (also termed ‘brine’) containing dissolved sodium values. For contact, the water or aqueous solution is injected into a cavity of the underground formation, to allow the solution to dissolve as much water-soluble trona ore as possible, and then the resulting brine is extracted to the surface. A portion of the brine can be used as feed stock to one or more processes to manufacture one or more sodium-based products, while another brine portion may be re-injected for additional contact with trona.

Solution mining of trona could indeed reduce or eliminate the costs of underground mining including sinking costly mining shafts and employing miners, hoisting, crushing, calcining, dissolving, clarification, solid/liquid/vapor waste handling and environmental compliance. The numerous salt (NaCl) solution mines operating throughout the world exemplify solution mining's potential low cost and environmental impact. But ores containing sodium carbonate and sodium bicarbonate (trona, wegscheiderite) have relatively low solubility in water at room temperature when compared with other evaporite minerals, such as halite (mostly sodium chloride) and potash (mostly potassium chloride), which are mined “in situ” with solution mining techniques.

Implementing a solution mining technique to exploit sodium (bi)carbonate-containing ores like trona ore, especially those ores whose thin beds and/or deep beds of depth greater than 2,000 ft (610 m) which are currently not economically viable via mechanical mining techniques, has proven to be quite challenging.

In 1945, Pike proposed the use of a single well comprising an outer casing and an inner casing. Hot solvent is injected through the inner casing to contact the trona bed, and the brine is withdrawn through the annulus. This method however proved unsuccessful and currently there are two approaches to trona solution mining that are being pursued.

One trona solution mining approach which is commercially used at the present time is part of an underground tailings disposal projects. Mine operators flood old workings, dissolving the pillars and recovering the dissolved sodium value. Solution mining of mine pillars was disclosed in U.S. Pat. No. 2,625,384 issued to Pike et al in 1953 entitled “Mining Operation”; it uses water as a solvent under ambient temperatures to extract trona from existing mined sections of the trona deposits. Solvay Chemicals, Inc. (SCI), known then as Tenneco Minerals was the first to begin depositing tails, from the refining process back into these mechanically mined voids left behind during normal partial extract operation. Applicants call this approach a ‘hybrid’ solution mining process as it takes advantage of the remnant voids and subsequent exposed surface areas of trona left behind from mechanical mining to both deposit insoluble materials and other contaminants (collectively called tailings or tails) and to recover sodium value from the aqueous solutions used to carry the tails.

Even though solution mining of remnant mechanically mined trona is one of the preferred mining methods in terms of both safety and productivity, there are several problems to be addressed, not the least of which is the resource itself. Hybrid solution mining processes are necessarily dependent upon the surface area and openings provided by mechanical mining to make them economically feasible and productive, but there is a finite amount of trona that has been previously mechanically mined. These ‘hybrid’ mining processes cannot exist in their present form without the necessity of prior mechanical mining in a partial extraction mode. When current trona target beds will be completely mechanically mined, the operators will eventually be forced to move into thinner beds and/or into beds of lower quality and to endure more rigorous mining conditions while the preferred beds are depleting and finally become exhausted.

This is where the second solution mining approach would allow the extraction of trona from less desirable beds (thin beds, poor quality beds, and/or deeper beds) which are currently less economically viable, without the negative impact of increased mining hazards and increased costs.

In this other trona solution mining approach, two or more vertical wells are drilled into the trona bed, and a low pressure connection is established by hydraulic fracturing or directional drilling.

Attempts to solution mine trona using vertical boreholes began soon after the 1940's discovery of trona in the Green River Basin in Wyoming. U.S. Pat. No. 3,050,290 entitled “Method of Recovery Sodium Values by Solution Mining of Trona” by Caldwell et al. discloses a process for solution mining of trona that suggests using a mining solution at a temperature of the order of 100-200° C. This process requires the use of recirculating a substantial portion of the mining solution removed from the formation back through the formation to maintain high temperatures of the solution. A bleed stream from the recirculated mining solution is conducted to a recovery process during each cycle and replaced by water or dilute mother liquor. U.S. Pat. No. 3,119,655 entitled “Evaporative Process for Producing Soda Ash from Trona” by Frint et al discloses a process for the recovery of soda ash from trona and recognizes that trona can be recovered by solution mining. This process includes introduction of water heated to about 130° C., and recovery of a solution from the underground formation at 90° C.

Directional drilling from the ground surface has been used to connect dual wells for solution mining bedded evaporite deposits and the production of sodium bicarbonate, potash, and salt. Nahcolite solution mining utilizes directionally drilled boreholes and a hot aqueous solution comprised of dissolved soda ash, sodium bicarbonate, and salt. Development of nahcolite solution mining cavities by using directionally drilled horizontal holes and vertical wells is described in U.S. Pat. No. 4,815,790, issued in 1989 to E. C. Rosar and R. Day, entitled “Nahcolite Solution Mining Process”. The use of directional drilling for trona solution mining is described in U.S. Patent Application Pre-Grant Publication No. US 2003/0029617 entitled “Application, Method and System For Single Well Solution Mining” by N. Brown and K. Nesselrode.

However, to improve the lateral expansion of a solution mined cavity in the evaporite deposit, multiple boreholes are needed, either by a plurality of well pairs for injection and production and/or by a plurality of lateral boreholes in various configurations such as those described in U.S. Pat. No. 8,057,765, issued in November 2011 to Day et al, entitled “Methods for Constructing Underground Borehole Configurations and Related Solution Mining Methods”. The cost of drilling horizontal boreholes and/or of directional drilling can add up. As a result, the benefit in cost savings sought by using solution mining may be negated by the use of expensive drilling operations to improve lateral development of cavity and/or expanding mining area.

As explained previously, a bed of trona ore typically overlays a floor made of oil shale, which is a water-insoluble incongruent material whereby the interface between these two materials forms a natural plane of weakness. If a sufficient amount of hydraulic pressure is applied at this interface, the two dissimilar substances (trona and shale) should easily separate thereby exposing a large free-surface of trona upon which a suitable solvent can be introduced for in situ solution mining.

In the late 1950's-early 1960's, hydraulic fracturing of trona has been proposed, claimed or discussed in patents as a means to connect two wells positioned in a trona bed by FMC Corporation. See for example U.S. Pat. No. 2,847,202 (1958) by Pullen, entitled “Methods for Mining Salt Using Two Wells Connected by Fluid Fracturing”; U.S. Pat. No. 2,952,449 (1960) by Bays, entitled “Method of Forming Underground Communication Between Boreholes”; U.S. Pat. No. 2,919,909 (1960) by Rule entitled “Controlled Caving For Solution Mining Methods”; U.S. Pat. No. 3,018,095 (1962) by Redlinger et al, entitled “Method of Hydraulic Fracturing in Underground Formations”; and GB 897566 (1962) by Bays entitled “Improvements in or relating to the Hydraulic Mining of Underground Mineral Deposits”.

In the 1980's, a borehole trona solution mine attempt by FMC Corporation involved connecting multiple conventionally drilled vertical wells along the base of a preferred trona bed by the use of hydraulic fracturing. FMC published a report (Frint, Engineering and Mining Journal, September 1985 “FMC's Newest Goal: Commercial Solution Mining Of Trona” including “Past attempts and failures”) promoting the hydraulic fracture well connection of well pairs as the new development that would commercialize trona solution mining. According to FMC's 1985 article though, the application of hydraulic fracturing for trona solution mining was found to be unreliable. Fracture communication attempts failed in some cases and in other cases gained communication between pre-drilled wells but not in the desired manner. The fracture communication project was eventually abandoned in the early 1990's.

These attempts of in situ solution mining of virgin trona in Wyoming were met with less than limited success, and technologies using hydraulic fracturing to connect wells in a trona bed failed to mature.

In the field of oil and gas drilling and operation however, hydraulic fracturing is a mainstay operation, and it is estimated that more than 60% new wells in 2011 used hydraulic fracturing to extract shale gas. Such hydraulic fracturing often employs directional drilling with horizontal section within a shale formation for the purpose of opening up the formation and increasing the flow of gas therefrom to a particular single well using multi-fracking events from one horizontal borehole in the formation.

Through this technique, it has been established that fractures produced in formations should be approximately perpendicular to the axis of the least stress and that in the general state of stress underground, the three principal stresses are unequal (anisotropic conditions). Where the main stress on the formation is the stress of the overburden, these fractures tend to develop in a vertical or inverted conical direction. Horizontal fractures cannot be produced by hydraulic pressures less than the total pressure of the overburden.

In fracturing between spaced wells in evaporite mineral formations for the purpose of removing the mineral by solution flowing between the adjacent wells, the ‘fracking’ methods used in the oil and gas industry are however not suitable to accomplish the formation of a single main horizontal fracture. Because the depth of the hydraulically-fractured formation is generally greater than 1,000 meters (3,280 ft), the injection pressures in oil and gas exploration are high, even though they are still less than the overburden pressure; this favors the formation of vertical fractures which increases permeability of the exploited shale formation. The main goal of ‘fracking’ methods in the oil and gas industry is indeed to increase the permeability of shale. Overburden gradient is generally estimated to be between 0.75 psi/ft (17 kPa/m) and 1.05 psi/ft (23.8 kPa/m), thus what is called the fracture gradient′ used in oil and gas fracking is less than the overburden gradient, preferably less than 1 psi/ft (22.6 kPa/m), preferably less than 0.95 psi/ft (21.5 kPa/m), sometimes less than 0.9 psi/ft (20.4 kPa/m). The ‘fracture gradient’ is a factor used to determine formation fracturing pressure as a function of well depth in units of psi/ft. For example, a fracture gradient of 0.7 psi/ft (15.8 kPa/m) in a well with a vertical depth of 2,440 m (8,000 ft) would provide a fracturing pressure of 5,600 psi (38.6 MPa).

Unlike the oil and gas exploration from shale formations where it is desirable to produce numerous vertical fractures near the center of the shale formation to recover the most oil and/or gas therefrom, in the recovery of a soluble mineral from underground evaporite formations, it is desirable to produce a single fracture substantially at the bottom of the evaporite mineral stratum and along the top of the underlying water-insoluble non-evaporite stratum and to direct the fracture to the next adjacent well along the interface between the bottom of the evaporite stratum to be removed and the top of the underlying stratum so that the soluble mineral will be dissolved from the bottom up.

Water-soluble evaporite formations, and particularly trona formations, usually consist in nearly horizontal beds of various thicknesses, underlain and overlain by water-insoluble sedimentary rocks like shale, mudstone, marlstone and siltstone. The surface of separation between the evaporite stratum and the underlying or overlying non-evaporite stratum is usually sharply defined. This surface of separation at any given point may lie substantially in a horizontal plane. In the U.S. Green River Basin, the depth of the surface of separation between the trona and oil shale strata is shallow, typically 3,000 ft (914 m) or less, preferably a depth of 2,500 ft (762 m) or less, more preferably a depth of 2,000 ft (610 m) or less. At sufficiently shallow depths, injection pressures equal to or slightly greater than the pressure of the overburden should favor the development of a horizontal fracture, particularly in the case where the desirable target fracture lies along a known plane of weakness between two incongruent materials such as the interface between trona and oil shale. When the water-soluble evaporite stratum is a nearly horizontal bed underlain by water-insoluble nearly horizontal sedimentary rock, the single main fracture (interface gap) created at their interface is substantially horizontal.

The bottom-up approach for dissolving the mineral from the interface gap (fracture) created substantially at the bottom of the evaporite stratum offers a number of advantages. The less concentrated and less saturated solvent present in the gap rises to a top layer of the solvent body inside the gap due to the density gradient, and contacts the bottom of the evaporite stratum, dissolves the mineral therefrom, and as the solvent becomes more saturated, settles to a lower layer of the solvent body so that the bottom edge of the evaporite stratum is always exposed to dissolution by less concentrated solvent. The insoluble materials in the evaporite formation can settle through the solvent body to the bottom of the solution-mining cavity and deposit thereon so that only clear solutions are recovered from production wells.

A further advantage of the bottom-up approach for solution mining of mineral is that it can help minimize contact of the solvent with contaminants-rich minerals (e.g., halite) which may be found in overlying strata such as green shale strata found above a trona stratum. Since these contaminants-rich minerals are generally soluble in the same solvent as the desirable mineral, if solvent flow is allowed to occur to reach contaminated overlying layers, this would allow contaminants from these overlying layers to dissolve into the solvent, thereby “poisoning” the resulting brine and rendering it useless or, at the very least, making its further processing into valuable product(s) very expensive. Indeed, poisoning by sodium chloride from chloride-based minerals can occur during solution mining of trona, and it is suspected that the solution mining efforts by FMC in the 1980's in the Green River Basin were mothballed in the 1990's due to high NaCl contamination in the extracted brine.

### SUMMARY OF THE INVENTION

To allow for the development of a bottom-up solution mining approach of a shallow-depth evaporite mineral stratum having a parting interface with an underlying non-evaporite stratum of a different composition, Applicants have developed a lithological displacement technique comprising lifting, and separating, the evaporite stratum from the underlying stratum by application of a fluid at the strata interface using a lifting hydraulic pressure. Once a mineral free-surface is hydraulically generated by such lifting step, the method may further comprise dissolving the mineral or a component of the mineral from the hydraulically-generated mineral free-surface which is in contact with a solvent to form a brine and extracting at least a portion of the brine to the ground surface. The lifting fluid may comprise or consist of a solvent suitable to dissolve the mineral, but not necessarily. The lifting fluid may be a fluid which has interesting properties such as a viscosity sufficient to efficiently maintain particles contained herein (such as proppant) in a well-dispersed manner so as to carry them all along the gap.

The present invention is particularly applicable to in situ solution mining of a lithologically-displaced evaporite mineral stratum and production of valuable products, such as rock salt, potash, soda ash, and/or derivatives thereof.

The present invention thus relates to a cost effective solution mining method of an evaporite mineral stratum comprising the creation of a mineral free-surface via lithological displacement using a lifting hydraulic pressure of an injected fluid applied at or near the interface between the evaporite stratum and a non-evaporite stratum and dissolution of mineral to create at this interface a cavity which can be subsequently solution mined.

A particular embodiment of the present invention relates to a method of solution mining of an evaporite stratum, in which the evaporite mineral stratum is in an underground formation lying immediately above a stratum of a different composition, said formation comprising a defined weak parting interface between the two strata and above which is defined an overburden up to the ground surface. This method comprises a lithological displacement of the evaporite mineral stratum, wherein a fluid is injected at the parting interface to lift the evaporite stratum at a lifting hydraulic pressure greater than the overburden pressure, thereby forming a gap at the interface and creating a mineral free-surface.

Another aspect of the present invention relates to a manufacturing process for making one or more sodium-based products from an evaporite mineral stratum comprising a water-soluble mineral selected from the group consisting of trona, nahcolite, wegscheiderite, and combinations thereof, said process comprising:
carrying out any aspect or embodiment of the method of solution mining of the evaporite stratum according to the present invention to obtain a brine comprising sodium carbonate and/or bicarbonate by dissolution of the mineral free surface by a solvent, and
passing at least a portion of said brine through one or more units selected from the group consisting a crystallizer, a reactor, and an electrodialysis unit, to form at least one sodium-based product.
   Such sodium-based product may be selected from the group consisting of sodium sesquicarbonate, sodium carbonate monohydrate, sodium carbonate decahydrate, sodium carbonate heptahydrate, anhydrous sodium carbonate, sodium bicarbonate, sodium sulfite, sodium bisulfite, sodium hydroxide, and other derivatives.

Yet another aspect of the present invention relates to a sodium-based product selected from the group consisting of sodium sesquicarbonate, sodium carbonate monohydrate, sodium carbonate decahydrate, sodium carbonate heptahydrate, anhydrous sodium carbonate, sodium bicarbonate, sodium sulfite, sodium bisulfite, sodium hydroxide, and other derivatives, said product being obtained by the manufacturing process according to the present invention.

The following may apply to any or all embodiments of such method, process, or product according of the present invention.

The evaporite mineral stratum may comprise a mineral which dissolves in a solvent to form a brine which can be used for the production of rock salt (NaCl), potash, soda ash, and/or derivatives thereof. The evaporite mineral stratum preferably comprises a water-soluble mineral selected from the group consisting of trona, nahcolite, wegscheiderite, shortite, northupite, pirssonite, dawsonite, sylvite, carnalite, halite, and combinations thereof. The evaporite mineral stratum preferably comprises a water-soluble mineral selected from the group consisting of trona, nahcolite, wegscheiderite, and combinations thereof, more preferably comprises trona. In such instance, the underlying water-insoluble stratum of a different composition typically, but not necessarily, includes an oil shale stratum.

The evaporite stratum is preferably at a shallow depth of 3,000 ft (914 m) or less, preferably of 2,500 feet (762 m) or less.

The defined parting interface between the two strata is preferably horizontal or near-horizontal with a dip of 5 degrees or less, but not necessarily.

The lifting hydraulic pressure applied at the interface may be selected by using a fracture gradient which is higher than the overburden gradient.

The lifting hydraulic pressure applied at the interface may be characterized by a fracture gradient between 0.9 psi/ft (20.4 kPa/m) and 1.5 psi/ft (34 kPa/m),

The lifting hydraulic pressure may be from 0.01% to 50% greater than the overburden pressure at the depth of the interface. The lifting hydraulic pressure preferably may be just above the pressure necessary to overcome the sum of the overburden pressure and the tensile strength of the strata interface.

The injected fluid used for lithological displacement of the evaporite mineral stratum may comprise a solvent suitable for dissolving the mineral.

The injected fluid may comprise water or an aqueous solution, such as sodium (bi)carbonate-containing solution and/or caustic solution. The injected fluid may comprise an aqueous alkaline solution. The injected fluid may comprise an unsaturated aqueous solution comprising sodium carbonate, sodium bicarbonate, sodium hydroxide, calcium hydroxide, or combinations thereof. The injected fluid may consist essentially of water.

The fluid may comprise or consist of a slurry comprising particles suspended in water or the aqueous solution. The particles may be any suitable water-insoluble matter. The particles may comprise tailings and/or a proppant. The particles may comprise tailings used as proppant. Such tailings may be obtained during refining of mechanically-mined trona. A proppant may be any suitable insoluble solid material with a size distribution that will “prop” open the hydraulically-induced gap in such a way as to allow passage and flow of fluid in the gap when using a lower hydraulic pressure in a later dissolution step.

The fluid injection is preferably carried out via a well which is drilled from ground surface through the evaporite stratum and which intersects the strata interface. The well may be a vertical well or a directionally drilled well. The well may be cemented and cased from the ground surface down to the interface or to an underground location below the interface thereby intersecting the interface.

The well comprises an in situ injection zone which is fluid communication with the interface. The in situ injection zone may comprise an end opening of a downhole borehole section and/or well casing perforations which are aligned with respect to the strata interface plane.

When the fluid injection is carried out via a vertical well which is drilled from the ground surface past the depth of the interface, the vertical well is cased and cemented through its entire length, but comprises an in situ injection zone being in fluid communication with the strata interface, said in situ injection zone of the vertical well comprising a downhole end opening and/or casing perforations.

When the fluid injection is carried out in a directionally drilled well, the directionally drilled well is cemented and cased, but comprises at least one horizontal borehole section comprising an in situ injection zone being in fluid communication with the strata interface; and the fluid injected through the well exits through the in situ injection zone of the horizontal borehole section, thereby lifting the overlying evaporite stratum at the interface so that the gap created at the interface is an extension of the horizontal borehole section.

The method may further comprise dissolving the mineral into a solvent from solvent-exposed free-surface created at the interface gap to form a brine and to enlarge the gap to form a mineral cavity. The solvent suitable for dissolving the mineral may be the same fluid injected at the interface for lithological displacement of the evaporite mineral stratum, but not necessarily.

The dissolution may be carried out at a hydraulic pressure equal to or less than hydrostatic head pressure in the cavity when a layer of insolubles at the bottom of the cavity provides support for the cavity ceiling. The layer of insolubles may include a propping material and/or in situ insoluble material.

The method may further comprise injecting a blanket medium so as to prevent dissolution of mineral from the ceiling of the cavity.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other methods for carrying out the same purposes of the present invention. It should also be realized by those skilled in the art that such equivalent constructions or methods do not depart from the spirit and scope of the invention as set forth in the appended claims.

### BRIEF DESCRIPTION OF THE DRAWINGS

For a detailed description of the preferred embodiments of the invention, reference will now be made to the accompanying drawings which are provided for example and not limitation, in which:

FIG. 1 illustrates an embodiment of a lithological displacement step (lifting step) in a solution mining of a trona stratum from an oil shale stratum using solvent injection in a vertical well;

FIG. 2 illustrates another embodiment of a lithological displacement (lifting) of a trona stratum from an oil shale stratum using solvent injection in a directionally drilled well via a horizontal borehole section which is located at or near a parting trona/shale interface;

FIG. 3 illustrates a side elevation view of a downhole horizontal section of a directional drilled well comprising an end opening for injecting fluid into the interface, wherein the end opening comprises holes with a smaller internal diameter than the downhole horizontal section;

FIG. 4a illustrates a side elevation view of a downhole horizontal section of a directional drilled well comprising an end opening and casing perforations for injecting fluid into the interface;

FIG. 4b illustrates a plan view of an embodiment of the downhole horizontal section of FIG. 4a with an end opening and casing perforations on both sidewalls of this section;

FIG. 4c illustrates a plan view of another embodiment of the downhole horizontal section of FIG. 4a with an end opening and casing perforations on only one sidewall of this section;

FIG. 4d illustrates a 3-dimensional view of the embodiment of the downhole horizontal section of FIG. 4b with an end opening and casing perforations on both sidewalls of this section;

FIG. 5a illustrates a side view of a downhole horizontal section of a directional drilled well without an end opening and comprising casing perforations for injecting fluid into the interface;

FIG. 5b illustrates a plan view of an embodiment of a downhole horizontal section of a directional drilled well with casing perforations on both sidewalls of this section and without an end opening;

FIG. 5c illustrates a plan view of another embodiment of a downhole horizontal section of a directional drilled well with casing perforations on only one sidewall of this section and without an end opening;

FIG. 6a illustrates a side view of an embodiment of a downhole section of a vertical well with casing perforations located along one circumference of this section for injecting fluid into the interface;

FIG. 6b illustrates a 3-dimensional view of the embodiment of the downhole section of a vertical well illustrated in FIG. 6a.

On the figures, identical numbers correspond to similar references.

Drawings are not to scale or proportions. Some features may have been blown out or enhanced in size to illustrate them better.

### DEFINITIONS AND NOMENCLATURES

For purposes of the present disclosure, certain terms are intended to have the following meanings.

The term ‘evaporite’ is intended to mean a water-soluble sedimentary rock made of, but not limited to, saline minerals such as trona, halite, nahcolite, sylvite, wegscheiderite, that result from precipitation driven by solar evaporation from aqueous brines of marine or lacustrine origin.

The term ‘mined-out’ in front of ‘trona’, ‘evaporite’, ‘ore’, or ‘cavity’ refers to any trona, evaporite, ore, or cavity which has been previously mined.

The term “fracture” when used herein as a verb refers to the propagation of any pre-existing (natural) fracture or fractures and the creation of any new fracture or fractures; and when used herein as a noun, refers to a fluid flow path in any portion of a formation, stratum or deposit which may be natural or hydraulically generated.

The term ‘lithological displacement’ as used herein to include a hydraulically-generated vertical displacement of an evaporite stratum (lift) at its interface with an (generally underlying) non-evaporite stratum. A “lithological displacement” may also include a lateral (horizontal) displacement of the evaporite stratum (slip), but slip is preferably avoided.

The term ‘overburden’ is defined as the column of material located above the target interface up to the ground surface. This overburden applies a pressure onto the interface which is identified by an overburden gradient (also called ‘overburden stress’, ‘gravitational stress’, ‘lithostatic stress’) in a vertical axis.

The term ‘TA’ or ‘Total Alkali’ as used herein refers to the weight percent in solution of sodium carbonate and/or sodium bicarbonate (which latter is conventionally expressed in terms of its equivalent sodium carbonate content) and is calculated as follows: TA wt %=(wt % Na₂CO₃)+0.631 (wt % NaHCO₃). For example, a solution containing 17 weight percent Na₂CO₃ and 4 weight percent NaHCO₃ would have a TA of 19.5 weight percent.

The term ‘liquor’ or ‘brine’ represents a solution containing a solvent and a dissolved mineral (such as dissolved trona) or at least one dissolved component of such mineral. A liquor or brine may be unsaturated or saturated in mineral.

The term ‘solvent-exposed’ in front of ‘trona’, ‘mineral’, “surface’, ‘face’ refers to any trona, mineral, surface, face which is in contact with a solvent or fluid.

As used herein, the term “solute” refers to a compound (e.g., mineral) which is soluble in water or an aqueous solution, unless otherwise stated in the disclosure.

As used herein, the terms “solubility”, “soluble”, “insoluble” as used herein refer to solubility/insolubility of a compound or solute in water or in an aqueous solution, unless otherwise stated in the disclosure.

The term “solution” as used herein refers to a composition which contains at least one solute in a solvent.

The term “slurry” refers to a composition which contains solid particles and a liquid phase.

The term “saturated” in relation to a solution refers to a composition which contains a solute dissolved in a liquid phase at a concentration equal to the solubility limit of such solute under the temperature and pressure of the composition.

The term “unsaturated” in relation to a solution as used herein refers to a composition which contains a dissolved solute at a concentration which is below the solubility limit of such solute under the temperature and pressure of the composition.

The term “(bi)carbonate” refers to the presence of both sodium bicarbonate and sodium carbonate in a composition, whether being in solid form (such as trona as a double salt) or being in liquid form (such as a liquor or brine). For example, a (bi)carbonate-containing stream describes a stream which contains both sodium bicarbonate and sodium carbonate.

A ‘surface’ parameter is a parameter characterizing a fluid, solvent and/or brine at the ground surface (terranean location), e.g., before injection into an underground cavity or after extraction from a cavity to surface.

An ‘in situ’ parameter is a parameter characterizing a fluid, solvent and/or brine in an underground cavity or void (subterranean location).

The term ‘comprising’ includes ‘consisting essentially of” and also “consisting of”.

A plurality of elements includes two or more elements.

Any reference to ‘an’ element is understood to encompass ‘one or more’ elements.

In the present disclosure, where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components, or any element or component recited in a list of recited elements or components may be omitted from this list. Further, it should be understood that elements and/or features of a composition, a process, or a method described herein can be combined in a variety of ways without departing from the scope and disclosures of the present teachings, whether explicit or implicit herein.

The use of the singular ‘a’ or ‘one’ herein includes the plural (and vice versa) unless specifically stated otherwise.

In addition, if the term “about” is used before a quantitative value, the present teachings also include the specific quantitative value itself, unless specifically stated otherwise. As used herein, the term “about” refers to a +−10% variation from the nominal value unless specifically stated otherwise.

It should be understood that throughout this specification, when a range is described as being useful, or suitable, or the like, it is intended that any and every amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 1.5” is to be read as indicating each and every possible number along the continuum between about 1 and about 1.5. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

### DETAILED DESCRIPTION OF THE PREFERRED EMBODIMENTS

The following detailed description illustrates embodiments of the present invention by way of example and not necessarily by way of limitation.

It should be noted that any feature described with respect to one aspect or one embodiment is interchangeable with another aspect or embodiment unless otherwise stated.

The present invention relates to in situ solution mining of a mineral in an underground formation comprising an evaporite mineral stratum in which the mineral is soluble in a removal (liquid) solvent, such evaporite stratum lying immediately above a non-evaporite stratum of a different composition which is insoluble in such removal solvent, wherein the underground formation has a defined weak parting interface between the two strata, in which an interface gap is initially created by lithologically displacement (lift) of the evaporite stratum and the overburden at the interface by application of a lifting hydraulic pressure greater than the overburden pressure, thereby forming a gap (main fracture) between the strata and creating a mineral free-surface.

The lifting hydraulic pressure is applied by injecting a fluid at a strata interface (preferably injected at a specific steady volumetric flow rate) until the desired lifting hydraulic pressure is reached. The fluid may comprise or be a solvent suitable for dissolving the mineral, but not necessarily. The fluid is preferably in liquid form, and may comprise solid particles or may be essentially free of solid particles.

In preferred embodiments, the method further comprises solution mining of the mineral in which mineral dissolution by a solvent and brine extraction follow solvent injection into the formed gap (main fracture) between the strata to expose the created mineral free-surface to the solvent. The gap is enlarged by dissolution of mineral from solvent-exposed free-surface, thus creating a mineral cavity and generating a brine containing dissolved mineral (or a dissolved component from the mineral). At least a portion of the brine is extracted from underground to the ground surface.

### Lifting Fluid Injection Via a Well

Lifting fluid injection may be carried out via a vertical well or a directionally drilled well.

The method of the present invention may further comprise forming at least one fully cased and cemented well which intersects the strata interface. This well will serve as an injection well and/or may serve as an extraction well.

Forming the well may include drilling a well from the surface to at least the depth of a target injection zone which is located neat or at the interface between the target block of evaporite stratum and the underlying stratum, followed by casing and cementing the well.

The well is preferably fully cemented and cased but with a downhole section which provides at least one in situ injection zone which is in fluid communication with the strata interface. The downhole well section may be a portion of the fully cemented and cased well which comprises at least one casing opening (which provides at least one in situ injection zone) which is in fluid communication with the strata interface. The lifting fluid (e.g., solvent) can flow through the opening(s) between the inside of the well and the strata interface. The casing of a well downhole section may be perforated and/or the well may be otherwise left open at the interface to expose the target in situ injection zone.

When the well is vertical, the in situ injection zone may comprise or consist of perforations (casing openings) in a downhole section of the well casing, preferably aligned alongside the strata interface. When the vertical well goes through the interface which is horizontal or near horizontal, perforations (casing openings) are preferably positioned on at least one casing circumference of this downhole section, such casing circumference being aligned alongside the strata interface.

When the well is directionally drilled, the directionally drilled well comprises an in situ injection zone which is located at or near the parting interface, wherein the injection zone may comprise or consist of an end opening of a horizontal downhole section of the well and/or specific casing perforations in the horizontal downhole section of the well casing, for example perforations on one sidewall or on opposite sidewalls of the well horizontal section which are aligned alongside the strata interface (such as a row of perforations on either sidewall or both sidewalls of the horizontal downhole section). In this instance, when the lifting fluid exits the in situ injection zone (well end opening and/or casing perforations) thereby lifting the overlying evaporite stratum at the interface, the gap created at the interface is an extension of such horizontal borehole section.

The method may further comprise perforating the casing on one lateral side or opposite lateral sides of a horizontal well section or on at least one circumference on a vertical well section, so as to create casing perforations aligned alongside the interface. When the interface is horizontal or near-horizontal, this perforating step may be carried out to allow passage of the injected fluid in a preferential lateral way through the formed perforations towards the horizontal or near-horizontal interface.

The opening(s) on the casing may be in fluid communication with a conduit inserted into the well to facilitate fluid flow from the ground surface to this well in situ injection zone.

The well when vertical is preferably drilled from the ground surface past the depth of the interface. The section of the well which is underneath the interface may be plugged from the bottom of the well up to the interface for the lifting step. Alternatively, the section of the well which is underneath the interface may comprise a collection zone (also termed a sump) and is preferably cased and cemented to collect the brine and/or insolubles. The section of the well which is underneath the interface may be initially plugged from the bottom of the well up to the interface for the lifting step and then drilled to form the sump to collect brine and possibly insolubles (e.g., remaining after mineral dissolution and/or intentionally added by mine operator).

In at least one embodiment, the in situ injection zone may be intentionally widened to form a ‘pre-lift’ slot between the overlying evaporite stratum and the underlying insoluble stratum, this ‘pre-lift’ slot providing a pre-existing “initial lifting surface” which would allow the hydraulic pressure exerted by the injected fluid to act upon this initial lifting surface preferentially in order to begin the initial separation of the two strata. The pre-lift slot may be created by directionally injecting a fluid (preferably comprising a solvent suitable to dissolve the mineral) under pressure via a rotating jet gun.

### Fluid Used in Lifting Step

The injected fluid may comprise (or consist of) water. The water in the fluid may originate from natural sources of fresh water, such as from rivers or lakes, or may be a treated water, such as a water stream exiting a wastewater treatment facility.

The fluid may comprise an aqueous solution comprising a desired solute (e.g., at least one component of the mineral which is to be solution mined).

The fluid may be caustic or acidic or neutral.

The aqueous solution in the fluid may contain one or more alkali compounds, such as sodium hydroxide, calcium hydroxide, or any other bases; one or more acids such as sulfuric acid, citric acid, hydrochloric acid, etc; or any combinations of two or more thereof.

The injected fluid may comprise an aqueous caustic solution.

For a sodium (bi)carbonate-containing mineral such as trona, nahcolite, and/or wegscheiderite, the desired solute is preferably selected from the group consisting of sodium sesquicarbonate, sodium carbonate, sodium bicarbonate, and mixtures thereof.

When the evaporite stratum comprises trona, the fluid preferably comprises water or an unsaturated aqueous solution comprising sodium carbonate, sodium bicarbonate, sodium hydroxide, calcium hydroxide, or combinations thereof.

Water may be used preferably as the fluid to create the gap at the interface and to enlarge the interface gap quickly by mineral dissolution to form the cavity.

The injected fluid may comprise or consist of a slurry comprising particles suspended in water or an aqueous solution (e.g., caustic and/or sodium (bi)carbonate-containing solution). The fluid may comprise or consist of a slurry comprising particles suspended in water or the aqueous solution. The particles may be any suitable water-insoluble matter, such as tailings, proppant particles, or combinations thereof.

In order to maintain and/or enhance the flowability of the hydraulically-created gap in the mineral stratum, particulates with high compressive strength (often referred to as “proppant”) may be deposited in the gap, for example, by injecting the lithological displacement fluid carrying the proppant. The proppant may prevent the gap from fully closing upon the release of the hydraulic pressure for extraction, forming fluid flow channels through which a production solvent may flow in a subsequent solution mining exploitation phase. The process of placing proppant in the interface gap is referred to herein as “propping” the interface. Although it may be desirable to use proppant in maintaining fluid flow paths in the interface gap, dissolution of mineral by the lithological displacement solvent will enlarge the gap over time to form a mineral cavity. As such, the proppant may be needed only during the interface gap formation and/or during nascent cavity development. But in some instances, this propping may be omitted from the lifting step.

The surface temperature of the injected fluid can vary from 32° F. (0° C.) to 250° F. (121° C.), preferably up to 220° F. (104° C.).

When the injected fluid comprises a solvent suitable for dissolving the mineral, the higher the injected fluid temperature, the higher the rate of dissolution at and near the point of injection.

Before injection, the lifting fluid may be preheated to a predetermined temperature which is higher than the in situ temperature of the evaporite stratum. When the injected fluid comprises a solvent for dissolving the mineral, the fluid may be preheated to increase the solubility of one or more desired solutes present in the mineral ore.

The fluid may be injected from the ground surface to the interface at a surface temperature at least 20° C. higher than the in situ temperature of the evaporite stratum.

The fluid may be injected from the ground surface to the interface at a surface temperature which is near the ambient rock temperature (the in situ temperature) at the injection depth. The surface temperature of the fluid may be within +/−5° C. or within +/−3° C. of the in situ temperature of the evaporite stratum. Since the in situ temperature of trona stratum 5 is estimated to be about 30-36° C. (86-96.8° F.), preferably 31-35° C. (87.8-95° F.), the surface temperature of the fluid may be between about 25 and about 41° C. (about 77-106° F.).

For trona solution mining, the surface temperature of the fluid for the lifting and/or dissolution steps may be between 59° F. and 194° F. (15-90° C.) or between 100° F. and 150° F. (37.8-65.6° C.), or between 122° F. and 176° F. (50-80° C.), or between 140° F. and 176° F. (60-80° C.), more preferably between 140° F. (60° C.) and 158° F. (70° C.), most preferably about 149° F. (65° C.).

The fluid may be injected at a volumetric flow rate from 9 to 477 cubic meters per hour (m³/hr) [42-2100 gallons per minute or 1-50 barrels per minute]; from 11 to 228 m³/hr [50-1000 GPM or 1.2-23.8 BBL/min]; or from 13 to 114 m³/hr (60-500 GPM or 1.4-11.9 BBL/min); or from 16 to 45 m³/hr (70-200 GPM or 1.7-4.8 BBL/min); or from 20 to 25 m³/hr (88-110 GPM or 2.1-2.6 BBL/min).

### Mineral Dissolution and Brine Extraction

In preferred embodiments, mineral dissolution by a production solvent and brine extraction follow the lifting step (lithological displacement) once the hydraulic pressure has reached the desired lifting pressure.

The dissolution may comprise stopping injection of the lifting fluid and injecting a production solvent to maintain the desired lifting hydraulic pressure during mineral dissolution of the gap.

Or the dissolution may comprise reducing the fluid flow rate to maintain the desired lifting hydraulic pressure during mineral dissolution, this option being preferred when the lifting fluid already comprises a solvent suitable for dissolving the mineral. It is expected that there will be fluid loss to the formation as it is not liquid-tight. This minimal flow of the fluid or production solvent may be necessary to compensate for the bleed-off of liquid to the formation.

The solvent remains inside the gap and by dissolution of the mineral with which it comes in contact, the solvent gets impregnated with dissolved mineral and forms a brine, and the gap gets enlarged into a mineral cavity. At least a portion of this brine may be extracted from the mineral cavity to the surface. Once the brine achieves a desired target mineral content (e.g., a minimum TA content of 8% or 15% for trona dissolution), the extracted brine may be used for further processing to form one or more products.

Alternatively, the dissolution step which follows the injection step once the hydraulic pressure has reached the desired lifting pressure, may be carried out by continuously injecting a production solvent into the gap to dissolve the mineral with which it comes in contact, so that the solvent gets impregnated with dissolved mineral and forms a brine, and the gap gets enlarged into a mineral cavity.

At least a portion of this brine may be extracted continuously from the mineral cavity in such a way as to maintain the desired pressure at the gap. The extracted brine may be recycled in part and re-injected into the cavity for additional enrichment in mineral.

Brine extraction may be carried out via one or more wells which may be vertical or directionally drilled. The same well used for injection may be used for extraction if the solution mining is operated in discontinuous mode.

The solution mining method of the present invention may further comprise forming another well which serves as an extraction well. This extraction well intersects the strata interface, may be fully cased and cemented but perforated at that interface to allow fluid communication between the mineral cavity and the inside of this well.

The dissolution and extraction steps may be carried out in continuous mode, in which the solvent is continuously injected, the mineral gets dissolved while the solvent flows through the mineral cavity, and at least a portion of the brine is continuously extracted.

Or the dissolution and extraction steps may be carried out in discontinuous mode, in which solvent injection and brine extraction are not continuous, and the dissolution and extraction steps may not be carried out simultaneously.

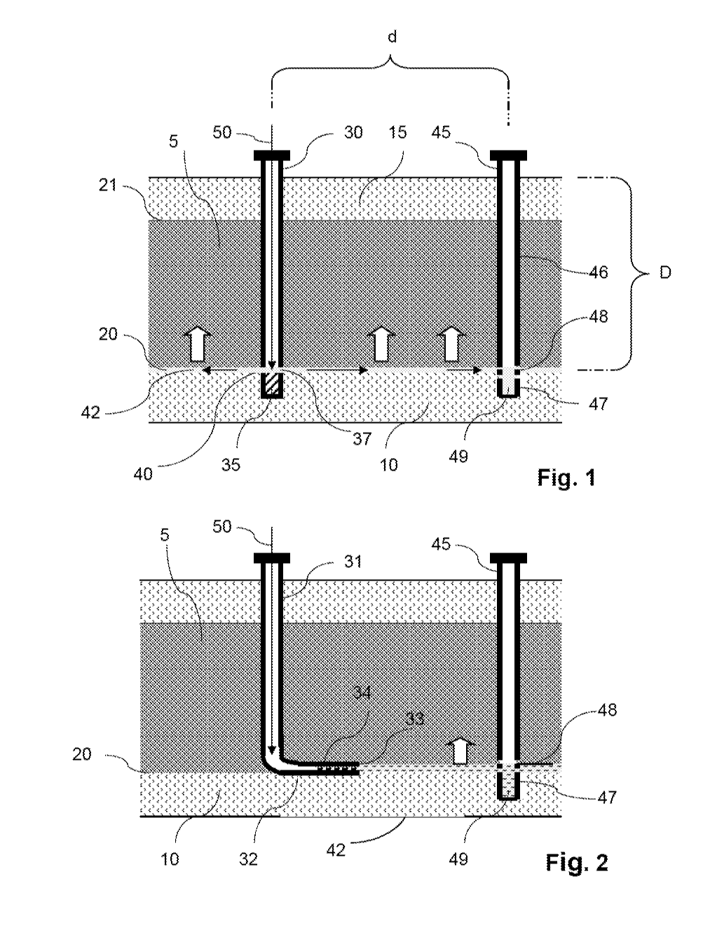

Embodiments concerning the lithological displacement step according to the present invention will now be described in reference to the following drawings: FIGS. 1 and 2.

Although FIGS. 1-2 are illustrated in the context of a trona/shale system and the application of hydraulic pressure at their underground interface, with respect to any or all embodiments of the present invention, the evaporite mineral to which the present method can be applied may be any suitable evaporite stratum containing a desirable mineral solute. The evaporite mineral stratum may comprise a mineral which is soluble in the solvent to form a brine which can be used for the production of rock salt (NaCl), potash (KCl), soda ash, and/or derivatives thereof. The evaporite mineral stratum may comprise for example a mineral selected from the group consisting of trona, nahcolite, wegscheiderite, shortite, northupite, pirssonite, dawsonite, sylvite, carnalite, halite, and combinations thereof. Preferably, the evaporite mineral stratum comprises any deposit containing sodium carbonate and/or bicarbonate. The evaporite mineral stratum preferably comprises a water-soluble mineral selected from the group consisting of trona, nahcolite, wegscheiderite, and combinations thereof. Most preferably, the evaporite mineral comprises trona. In such instance, the underlying water-insoluble stratum of a different composition may include oil shale or any substantially water-insoluble sedimentary rock that has a weak bond interface with the target evaporite stratum.

The overburden is defined as the column of material located above the strata interface up to the ground surface. This overburden applies a pressure onto this interface which is identified by an overburden gradient (also called ‘overburden stress’, ‘gravitational stress’, ‘lithostatic stress’) in a vertical axis.

In FIGS. 1 and 2, a trona stratum 5 is overlying an oil shale stratum 10 and is underlying another non-evaporite stratum 15 (generally another shale stratum which may be contaminated with chloride-containing bands). There is a defined parting interface 20 between the strata 5 and 10. There is also a parting interface 21 between the strata 5 and 15. The application of hydraulic pressure is preferably carried out at the interface 20.

The trona stratum 5 may contain up to 99 wt % sodium sesquicarbonate, preferably from 25 to 98 wt % sodium sesquicarbonate, more preferably from 50 to 97 wt % sodium sesquicarbonate.

The trona stratum 5 may contain up to 1 wt % sodium chloride, preferably up to 0.8 wt % NaCl, yet more preferably up to 0.2 wt % NaCl.

The defined parting interface 20 between the strata 5 and 10 is preferably horizontal or near-horizontal, but not necessarily. The interface 20 may be characterized by a dip of 5 degrees or less; preferably with a dip of 3 degrees or less; more preferably with a dip of 1 degrees or less. The defined parting interface 20 may have a dip greater than 5 degrees up to 45 degrees or more.

The trona/shale interface 20 may at a shallow depth ‘D’ of less than 3,280 ft (1,000 m) or at a depth of 3,000 ft (914 m) or less, preferably at a depth of 2,500 ft (762 m) or less, more preferably at a depth of 2,000 ft (610 m) or less. The trona/shale interface 20 may at a depth ‘D’ of more than 800 ft (244 m).

In the Green River Basin, the trona/oil shale parting interface 20 may be at a shallow depth of from 800 to 2,500 feet (244-762 m).

In the Green River Basin, the trona stratum 5 may have a thickness of from 5 feet to 30 feet (1.5-9.1 m), or may be thinner with a thickness from 5 to 15 feet (1.5-4.6 m).

One embodiment of the lithological displacement technique which uses at least one vertical injection well and at least one vertical extraction well is illustrated in FIG. 1.

The method may first comprise drilling at least one, but possibly more, vertical well(s) 30 from the ground down to a depth below the interface 20. The portion 35 of the well 30 which is underneath the interface 20 is preferably plugged. The depth at which the bottom of well portion 35 lies (where the drilling of well 30 stops) may be at least 5 feet below the depth of interface 20, preferably between 10 feet and 100 feet below the depth of interface 20, more preferably between 30 feet and 80 feet below the depth of interface 20.

The well 30 is preferably fully cemented and cased, except that it comprises an in situ injection zone 40 which is in fluid communication with the strata interface 20. The in situ injection zone 40 should allow for a fluid to be injected into the well 30 and to be directed at the interface 20. The in situ injection zone 40 is preferably, albeit not necessarily, designed to laterally inject the fluid in order to avoid injection of fluid in a vertical direction. The in situ injection zone 40 allows the fluid to force a path at the trona/shale interface 20 by vertically displacing the stratum 5 to create the gap 42.

The in situ injection zone 40 may comprise one or more downhole casing openings. A downhole vertical section of the vertical well 30 may have a downhole end opening which is located at or near the parting interface 20. The vertical borehole section may have, alternatively or additionally, perforations 37 which are aligned with the interface. Using a downhole perforating tool, perforations 37 may be cut through the casing and cement at a well circumference 38 aligned with the interface 20 to form the in situ injection zone 40. FIG. 6a (side-view) and FIG. 6b (3-D view) illustrate an embodiment of a borehole vertical section of well 30 comprising the in situ injection zone 40, in which several casing perforations 37 aligned along one well circumference 38 serve to inject the fluid 50 in situ into the interface 20.

The fluid can flow inside the casing of well 30 or may be injected via a conduit (not shown) all the way to the in situ injection zone 40. Such conduit may be inserted inside the injection well 30 to facilitate injection of fluid. The conduit may be inserted while the injection well 30 is drilled, or may be inserted after drilling is complete. The injection conduit may comprise a tubing string, where tubes are connected end-to-end to each other in a series in a somewhat seamless fashion. The injection conduit may comprise or consist of a coiled tubing, where the conduit is a seamless flexible single tubular unit. The injection conduit may be made of any suitable material, such as for example steel or any suitable polymeric material (e.g., high-density polyethylene). The injection conduit inside well 30 should be in fluid communication with the in situ injection zone 40.

For extraction of brine, one or more vertical wells which may be used as extraction wells are drilled at a distance from the vertical well 30 used as injection well. One vertical extraction well 45 is illustrated in FIG. 1.

The vertical extraction well 45 may be spaced from the vertical injection well 30 by a distance ‘d’ of at most 1,000 meters, or at most 800 meters, or at most 600 meters. Preferred spacing ‘d’ between injection and extraction wells may be from 100 to 600 meters, preferably from 100 to 500 meters.

The extraction well 45 may be cemented and cased from the surface down past the bottom of the trona stratum 5 which is defined by the interface 20, and which penetrates a portion of the oil shale stratum 10 with a downhole section 47. The downhole section 47 may be left uncased and uncemented, so that brine flowing therethrough may have contact with the walls of the downhole section 47 of well 45.

Preferably, the well 45 is cemented and cased all the way down including in downhole section 47, but the downhole section 47 is perforated where it intersects the interface 20. Using a downhole perforating tool, perforations 48 may be cut through the casing and cement at the interface 20. As shown in FIG. 1, these perforations 48 would allow the brine 65 to enter the lumen of well 45 to allow the brine 65 to be collected in a sump 49 (collection zone) inside the downhole section 47 of the extraction well 45 in order for at least a portion of the collected brine to be extracted at the surface.

The sump 49 may be created at the downhole section 47 of extraction well 45 to facilitate the recovery of the brine from the gap 42. The formation of the sump 49 is preferably carried out by mechanical means (such as drilling past the trona/shale interface 20). The bottom of sump 49 may have a greater depth than the bottom of the trona stratum 5. The sump 49 may be embedded at least partially or completely into the oil shale stratum 10. The walls and bottom of sump 49 are preferably cased and cemented.

A pumping system (not illustrated) may be installed so that the brine 65 can be pumped to the surface for further processing and recovery of valuable products. Suitable pumping system can be installed at the downhole section 47 of extraction well 45 or at the surface end of this well. This pumping system might be an ‘in-mine’ system in the sump 49 (e.g., downhole pump (not shown) which would permit to push at least a portion of the brine 65 out from underground to the ground surface) or a ‘terranean’ system (e.g., a pumping system which would permit to pull at least a portion of the brine 65 out from underground to the ground surface). A brine return pipe (not shown) may be placed into the sump 49 in fluid communication with the terranean pumping system to allow the brine 65 to be pumped to the surface during extraction.

Now is described how the system of FIG. 1 operates in the context of the present invention for lifting the trona stratum.

The fluid 50 is injected via injection zone 40 of the injection well 30 at the interface 20 between the trona stratum 5 and the underlying oil shale stratum 10 until a target lifting hydraulic pressure is reached. The lifting hydraulic pressure applied by injecting the fluid at the interface 20 is preferably greater than the overburden pressure. The application of hydraulic pressure by injection of fluid at the interface 20 lifts the overlying trona stratum 5 and the overburden, thereby creating a main horizontal fracture (gap 42).

The lifting hydraulic pressure application of the present invention is significantly different than the commercially-available hydraulic fracturing using very high pressures in deep oil and gas formations like in shale fracturing where the intent is the creation of numerous vertical fractures in the actual rock mass at much greater depth (>4,000 ft=1,219 m) under much greater overburden pressure.

That is why the Applicants refer to the present lifting step used in the solution mining method as a lithological displacement′ in order to distinguish it, as a less invasive process, from the high pressure hydraulic fracturing used in oil and gas fields. The present lithological displacement′ technique comprises applying a low hydraulic pressure to make a separation at a natural shallow-depth plane of weakness between a nearly horizontal bedded, soluble evaporite stratum (e.g., trona) and a dissimilar stratum (e.g., oil shale) in order to create a large mineral free-surface that a suitable solvent (e.g., water or aqueous solution) can contact to initiate in situ solution mining.

For this lithological displacement to be carried out on trona ore, the depth of the trona/shale interface is sufficiently shallow (e.g., at interface depths of less than 1,000 m) so as to encourage the development under hydraulic pressure of a main horizontal or near-horizontal fracture extending laterally away from the in situ injection zone at this interface between the trona stratum and the underlying oil shale stratum.

During lithological displacement of the target block of trona stratum 5 in the lifting step, the extraction well 45 should be capped. The injection well 30 should also be capped but will allow the fluid to be injected therethrough.

A fracture will open in the direction perpendicular to minimum principal stress. To propagate a fracture in an isotropic medium in the horizontal direction, the minimum principal stress must be vertical. The vertical stress at the trona/shale interface 20 coincides with the overburden pressure. It is generally prudent to select a fracture gradient for lithological displacement to be slightly higher than the overburden gradient to propagate a horizontal fracture initiated at the injection zone 40 along the parting interface 20.

The fracture gradient used will be estimated depending on the local underground stress field and the tensile strength of the trona/shale interface. The fracture gradient used for estimating the target lifting pressure for lithological displacement is equal to or greater than 0.9 psi/ft, or equal to or greater than 0.95 psi/ft, preferably equal to or greater than 1 psi/ft. The fracture gradient used for estimating the target lifting pressure for lithological displacement may be 1.5 psi/ft or less; or 1.4 psi/ft or less; or 1.3 psi/ft or less; or 1.2 psi/ft or less; or 1.1 psi/ft or less; or even 1.05 psi/ft or less. The fracture gradient may be between 0.9 psi/ft (20.4 kPa/m) and 1.5 psi/ft (34 kPa/m); preferably between 0.90 and 1.30 psi/ft; yet more preferably between 1 and 1.25 psi/ft; most preferably between 1 and 1.10 psi/ft. The fracture gradient may alternatively be from 0.95 psi/ft to 1.2 psi/ft; or from about 0.95 psi/ft to about 1.1 psi/ft, or from about 1 psi/ft to about 1.05 psi/ft. For example, for a depth of 2,000 ft for interface 20, a minimum target hydraulic pressure of 2,000 psi may be applied at interface 20 by the injection of the fluid to lift the overburden with the stratum 5 immediately above the targeted zone to be lifted, which represents the interface 20 between the trona and the oil shale.

The lifting hydraulic pressure may be at least 0.01% greater, or at least 0.1% greater, or at least 1% greater, or at least 3% greater, or at least 5% greater, or at least 7% greater, or at least 10% greater, than the overburden pressure at the depth of the interface. The hydraulic pressure during the lifting step may be at most 50% greater, or at most 40% greater, or at most 30% greater, or at most 20% greater, than the overburden pressure at the depth of the interface. The lifting hydraulic pressure may be from 0.01% to 50% greater, or from 0.1% to 50% greater, or even from 1% to 50% greater, than the overburden pressure at the depth of the interface. The lifting hydraulic pressure should be sufficient to overcome the sum of the overburden pressure and the tensile strength of the interface.

The targeted block of trona stratum 5 to be lifted is located at shallow depth where the vertical stress should be sufficiently low, and it is known to have very low tensile strength, considerably weaker than either the trona or the oil shale. The combination of both low vertical stress and a very weak horizontal interface creates very favorable conditions for the propagation of a horizontal hydraulically induced lithological displacement to create the gap 42.

The gap 42 provides a trona free-surface 22 which is mostly the bottom of the lifted target block of trona stratum 5. Contact with this trona free-surface 22 can be made with a solvent when the gap 42 is filled with this solvent.

The formation of gap 42 in this lithological displacement may extend laterally in all directions away from the injection zone 40 for a considerable lateral distance from 30 meters (about 100 feet), up to 150 m (about 500 ft), up to 300 m (about 1,000 ft), up to 500 m (about 1,640 ft), or even up to 610 m (about 2,000 ft) away. Because it is expected that the stresses are not equal in all directions, the lateral expansion will not be even in the horizontal plane. The width of the gap 42 however would be much less than 1 cm, generally about 0.5-1 cm near the in situ injection zone up to 0.25 cm at the extreme edge of the lateral expanse. The width of the gap 42 is highly dependent upon the flow rate of the fluid during lithological displacement.

Ideally during lithological displacement, the lateral expanse of the gap 42 intercepts the perforated downhole section 47 of at least one extraction well 45. In this manner, fluid communication is established between the injection well 30 and the extraction well 45 as shown in FIG. 1.

Another embodiment for the lithological displacement (lifting) of a trona stratum using a directionally drilled well for injection will now be described with reference to the following drawing: FIG. 2.

The method may comprise drilling a directionally drilled well 31 from the ground surface to travel more horizontally down to the depth of the interface 20. A horizontal section 32 of well 31 is drilled intersecting the interface 20. The bottom edge of the section 32 may be underneath the interface 20.

The fluid is injected in the directionally drilled well 31 and flows out of the well 31 through the in situ injection zone 40 which may comprise one or more downhole casing openings. The in situ injection zone 40 is in fluid communication with the strata interface 20.

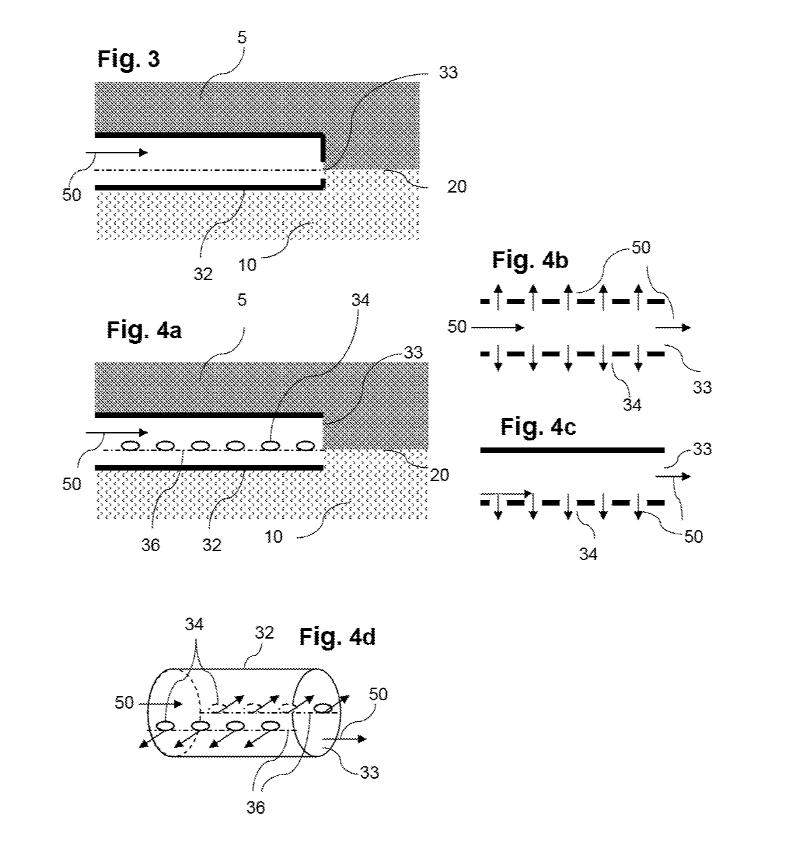

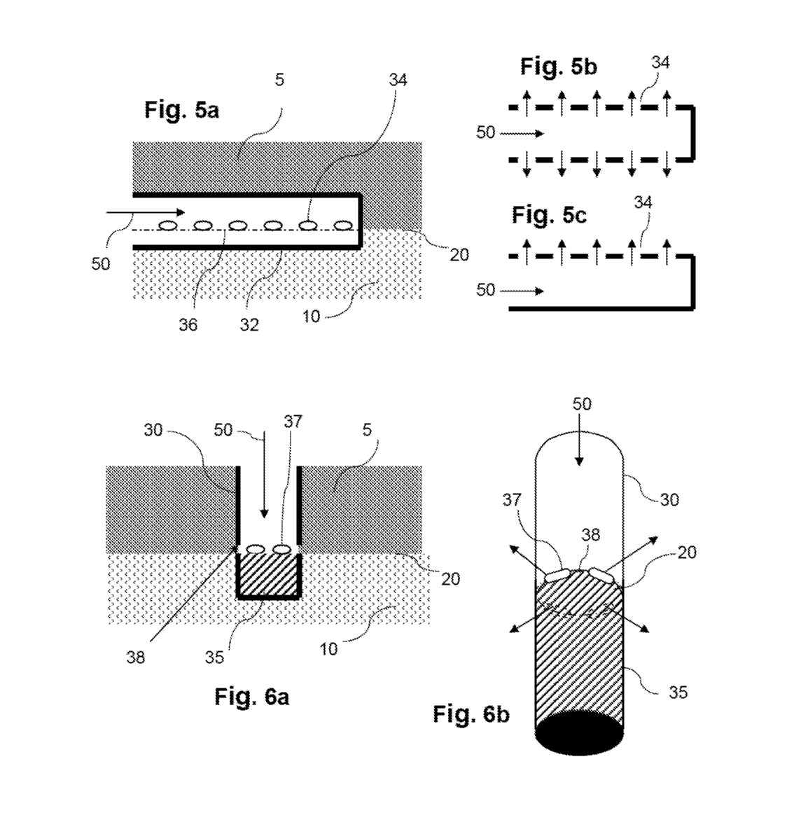

The horizontal borehole section 32 may have a downhole end opening 33 which is located at or near the parting interface 20. The downhole end opening 33 may comprise one or more holes with a smaller diameter than the internal diameter of the section 32 and may consist of the entire downhole end of the section 32. The horizontal borehole section 32 may have, alternatively or additionally, perforations 34 which are located at or near the parting interface 20. In some embodiments, the perforations 34 may be placed along at least one generatrix 36 of the casing of the horizontal section 32, the generatrix 36 being generally aligned with the interface (see for example FIGS. 4a, 4d, and 5a). However, perforations 34 do not necessarily need to be aligned with the interface 20.

The one or more casing openings are preferably selected from the group consisting of the downhole end opening 33, casing perforations 34, and combinations thereof. The casing opening(s) would provide a suitable in situ injection zone through which the fluid can flow to enter the interface plane.

In the directionally drilled horizontal well 31, the gap 42 may be created as an extension of the borehole section 32 where the fluid 50 exits its downhole casing opening(s).

Several ways in creating the gap 42 by means of fluid injection are illustrated by various views in FIGS. 3 to 5. FIG. 3, 4a, 5a (side-view), FIG. 4b, 4c, 5b, 5c (plan view) and FIG. 4d (3-D view) illustrate various embodiments of the downhole borehole section 32, in which one or more casing openings (e.g., end opening 33 and/or casing perforations 34) serve to inject the fluid 50 in situ into the interface 20 as follows:
injecting the lifting fluid 50 from only the downhole end opening 33 of the borehole section 32 (see side view of cylindrical section 32 in FIG. 3 in which the downhole end opening 33 comprises one or more holes with a smaller diameter than the internal diameter of the cylindrical section 32);
injecting the lifting fluid 50 through the downhole end opening 33 of borehole section 32 and through casing perforations 34 perforating the casing of the section 32 along at least a portion of its length and being aligned along at least one generatrix 36 of section 32, preferably perforating the entire length of the borehole section 32 (see side view of cylindrical section 32 in FIG. 4a illustrating end opening 33 of section 32 and casing perforations 34), the perforations being either on two generatrices 36 of cylindrical section 32 which are aligned with the interface 20 so as to laterally inject fluid 50 from both sidewalls of the horizontal section 32 (see 3-dimensional view of section 32 in FIG. 4d and plan view of section 32 in FIG. 4b with two rows of perforations 34) or on one generatrix 36 which is aligned with the interface 20 so as to laterally inject fluid 50 from only one sidewall of the horizontal section 32 (see plan view of section 32 in FIG. 4c with one row of perforations 34); or
injecting the lifting fluid 50 through only side casing perforations 34 along at least one generatrix 36 of at least a portion of the horizontal borehole section 32 (the end opening 33 being closed or impermeable to fluid flow in this embodiment), said generatrix 36 being aligned with the interface 20, the perforations 34 preferably perforating the entire casing length of the borehole section 32 (see side view of cylindrical section 32 in FIG. 5a illustrating only casing perforations 34), the perforations being either on two generatrices 36 of cylindrical section 32 which are aligned with the interface 20 so as to laterally inject fluid 50 from both sidewalls of the horizontal section 32 (see plan view of section 32 in FIG. 5b with two rows of perforations 34) or on one generatrix 36 which is aligned with the interface 20 so as to laterally inject fluid 50 from only one sidewall of the horizontal section 32 (see plan view of section 32 in FIG. 5c with one row of perforations 34).

It is to be noted that the alignment of the casing perforations (perforations 34 for directionally-drilled shell 31 or perforations 37 for vertical well 30) with the interface has been described above in the context of FIG. 4-6. However, it should be understood that such alignment is not required for adequate lifting the evaporite stratum at the interface. Additionally, these casing perforations (34, 37) are illustrated as being oblong with their main axis being somewhat aligned with the interface 20. However, vertical slits or circular holes or any shaped punctures with a main axis being misaligned with the interface 20 are equally suitable so long as they are located at or near the interface 20 to permit fluid flow from these perforations to the interface 20. Since casing perforations (34, 37) should be near proximity to the interface 20 and since hydraulic pressure acts in all directions equally, even fluid injected from a vertical perforation or any shaped puncture not aligned with the interface 20 should find its way to the interface 20.

Similarly as described earlier for FIG. 1, the lateral extent of the gap 42 should intersect the perforated section 47 of at least one extraction well 45 in FIG. 2. The extraction well(s) 45 may be vertical or may be directionally drilled with a horizontal section.

The extraction well 45 may be drilled at a certain distance ‘d’ from the downhole location of the in situ injection zone 40 so that the main fluid vector is directed towards the extraction well 45.

The gap 42 may be created as an axial extension of a well's horizontal borehole section 32 when the fluid 50 exits its downhole end opening 33.

The gap 42 may be created as a lateral extension of this horizontal borehole section 32 when the fluid 50 exits sidewall perforations 34 located on one or more generatrices 36 of the borehole section 32.

The gap 42 may be created as a lateral and axial extension of this horizontal borehole section 32 when the fluid 50 exits end opening 33 and sidewall perforations 34 located on one or more generatrices 36 of the borehole section 32.

For injection of the lifting fluid 50, water may be used initially to create the gap 42 at the interface 20 and to enlarge the gap 42 to form a cavity. The injected water may be extracted by flowback into well 30 to drain the cavity of liquid.

The injected fluid 50 is preferably injected at a volumetric flow rate from 7 to 358 cubic meters per hour (m³/hr) [31.7-1575 gallons per minute or 1-50 barrels per minute], to allow the hydraulic pressure to rise at the in situ injection zone 40 until it reaches a target lifting hydraulic pressure (estimated to be the interface depth times the overburden gradient plus a small additional pressure gradient necessary to overcome the tensile strength of the interface, and the frictional resistance to fluid flow). Other suitable fluid flow rates have been previously described. At this point, the flow of injected fluid 50 may be stopped or, at the very least, reduced to a very low flow rate, but the lifting hydraulic pressure is maintained.

The injected fluid 50 may comprise water or an unsaturated aqueous solution comprising sodium carbonate, sodium bicarbonate, sodium hydroxide, calcium hydroxide, or combinations thereof.

Water may be used preferably initially as fluid 50 to create the gap 42 at the interface 20 and to enlarge it quickly by mineral dissolution to form the cavity.

The injected fluid 50 may comprise or consist of a slurry comprising particles suspended in water or an aqueous solution (e.g., caustic solution). The particles may be tailings, proppant particles, or combinations thereof. The particles may comprise or consist of tailings used as proppant. These particles are generally water-insoluble.

The fluid 50 may be preheated before injection. When the fluid 50 comprises a solvent suitable for trona dissolution (such as water or an aqueous medium), the fluid 50 may be preheated to a predetermined temperature higher than the in situ temperature of trona to increase the solubility of trona.

The fluid 50 may be injected from the ground surface to the interface 20 at a surface temperature at least 20° C. higher than the in situ temperature of trona.

The fluid 50 may be injected from the ground surface to the interface at a surface temperature which is near the ambient trona temperature (the in situ temperature) at the injection depth. The surface temperature of the fluid 50 may be within +/−5° C. or within +/−3° C. of the in situ temperature of the trona stratum 5. Since the in situ temperature of trona stratum 5 is estimated to be about 30-36° C. (86-96.8° F.), preferably 31-35° C. (87.8-95° F.), the surface temperature of the fluid 50 may be between about 25 and about 41° C. (about 77-106° F.).

### Dissolution Step

Once the mineral cavity is formed at the interface during the lithological displacement step, exploitation of the mineral by solution mining of this cavity can take place with the use of a production solvent.

In a continuous mode, the production solvent is injected into the gap, so that the flowing production solvent dissolves the mineral from the solvent-exposed mineral free-surface and gets impregnated with dissolved mineral and forms a brine, and the gap gets enlarged into a mineral cavity, while at the same time at least a portion of the resulting brine is extracted to the surface. A portion of or all of the extracted brine may be recycled and re-injected into the cavity for additional enrichment in mineral, especially when the content of desired solute of the brine is not sufficiently high to allow its economical processing to make salable products.

In preferred embodiments in which trona is dissolved, the dissolution inside the cavity may be sufficient to obtain a brine saturated in sodium carbonate and/or bicarbonate. The trona dissolution inside the cavity may be sufficient to obtain a TA content in the brine of at least 8 wt %, preferably at least 10%, more preferably at least 15%.

It is also envisioned that the dissolution step may be carried out using a batch mode technique. In such case, the production solvent is first injected until the production solvent partially or completely fills the gap or mined-out cavity and thereafter the production solvent is maintained stationary to dissolve in place the solvent-exposed mineral free-surface. Hence this step may be referred to a ‘soaking’ step. Once the brine gets laden with dissolved solute (for example reaches at least 8% TA or even at least 15% for trona mining), the resulting brine is removed to the surface. When the mined-out cavity is partially or completely drained, more production solvent can be injected into the cavity, and the batch technique is repeated.

In some embodiments, the batch dissolution step may further comprise: stopping injection of the solvent or reducing the flow rate of the solvent to maintain the target lifting hydraulic pressure during mineral dissolution. It is expected that there will be solvent loss to the underground formation as it is not liquid-tight. Because there will be some “bleed off” to the formation, the solvent injection from the ground surface may not be stopped in practicality, but its flow rate should be much lower during the soaking step compared to the fluid flow rate used during the lifting step, and may be carried out solely to maintain the lifting hydraulic pressure close to the target value selected by the mine operator. Because the solvent injection is stopped or reduced to a very low flow rate, there is little flow disturbance in the cavity so that the solvent is substantially left stationary inside.

The dissolution may be carried out at hydrostatic head pressure (at the depth at which the solution-mined cavity is enlarged), in which the cavity is filled with solvent. By flooding the cavity, the production solvent contacts the cavity ceiling and, upon contact with the mineral, dissolves it.

Because the mineral stratum is not pure (contains insoluble matter), a layer of insolubles may be deposited during dissolution in the mined-out cavity. This layer of insoluble separates the floor and ceiling of the mined-out cavity, while mechanically supporting the cavity ceiling and maintaining the mineral free-surface on the cavity ceiling accessible to the production solvent. Such insoluble layer gets thicker as more and more of the mineral from the cavity ceiling get dissolved, and provides, through its porosity, a channel through which the production solvent can pass.

When the mined-out cavity is self-supported by mineral rubble fractured from the cavity ceiling and/or by a layer of water insoluble material, the mineral dissolution may be carried out at a hydraulic pressure below hydrostatic head pressure. This is preferably done when the development of the mined-out cavity is mature, that is to say, when the mineral cavity created by several rounds of dissolution is now self-supported without having to apply a hydraulic pressure greater than the overburden pressure to keep it open. Due to too high overburden weight on an unsupported roof span of the mineral cavity, blocks of mineral rubble get fractured in the cavity ceiling and, as a result, mineral rubble lay inside the mineral cavity. In this instance, the cavity not only contains a layer of insolubles but also mineral rubble, both of which now support the new cavity ceiling. In this situation, it is not necessary to flood the cavity with the production solvent to access the cavity ceiling's mineral free-surface, because the mineral rubble now inside the cavity provides plenty of mineral free-surfaces for the production solvent to contact and dissolve to form the brine.

The brine contains dissolved mineral. For trona solution mining, the brine preferably comprises sodium carbonate, sodium bicarbonate, or combinations thereof. The brine may become saturated with sodium carbonate and/or sodium bicarbonate.

The time sufficient for mineral dissolution is temperature dependent and may be from 5 minutes to 72 hours, preferably from 5 minutes to 24 hours, more preferably from 10 minutes to 12 hours.

The time for dissolution may be sufficient to obtain a TA content in the brine of at least 8 wt %, preferably at least 10%, more preferably at least 15%.

In preferred embodiments, the time for mineral dissolution may be sufficient to obtain a brine saturated in sodium carbonate and/or bicarbonate.

### Production Solvent

The components of the solvent used during dissolution may be the same as or different than the components of the lifting fluid used for lithological displacement.

The solvent injected for mineral dissolution (sometime called ‘production’ solvent) may be water or may comprise an aqueous solution comprising a desired solute (e.g., at least one component of the mineral). The desired solute is preferably selected from the group consisting of sodium sesquicarbonate, sodium carbonate, sodium bicarbonate, and mixtures thereof, and the production solvent may consist of water or may comprise an aqueous solution comprising sodium carbonate, sodium bicarbonate, sodium hydroxide, calcium hydroxide, or combinations thereof.

The production solvent may comprise at least in part an aqueous solution which is unsaturated in the desired solute. For example in solution mining of trona, the production solvent may comprise a brine which is unsaturated in sodium carbonate and which may be recycled from the same solution-mined target trona stratum and/or from another solution-mined trona stratum which may be adjacent to or underneath or above the target trona stratum.

The water in the production solvent may originate from natural sources of fresh water, such as from rivers or lakes, or may be a treated water, such as a water stream exiting a wastewater treatment facility.

The production solvent may be caustic or acidic or neutral. The aqueous solution in the production solvent may contain a soluble alkali or acid compound, such as sodium hydroxide, calcium hydroxide, or any other bases, one or more acids such as sulfuric acid, citric acid, hydrochloric acid, etc, or any combinations of two or more thereof.

The production solvent is preferably substantially free of solid particles.

In the case of trona stratum, the production solvent may be an aqueous solution containing a base (such as NaOH), or other compound that can enhance the dissolution of trona in the solvent and/or can convert sodium bicarbonate to sodium carbonate in situ.

The production solvent employed in the in-situ trona solution mining step may comprise or may consist essentially of a weak caustic solution for such solution may have one or more of the following advantages. The dissolution of sodium values with weak caustic solution is more effective, thus requiring less contact time with the trona ore. The use of the weak caustic solution also eliminates the ‘bicarb blinding’ effect, as it facilitates the in situ conversion of sodium bicarbonate to carbonate (as opposed to performing the conversion ex situ on the surface after brine extraction). It also allows more dissolution of sodium bicarbonate than would normally be dissolved with water alone, thus providing a boost in production rate. It may further leave in the mined-out cavity an insoluble carbonate such as calcium carbonate which may be useful during the mining operation.

It should be noted that the composition of the production solvent may be modified during the course of the mineral solution mining operation. For example, for trona mining, water as production solvent may be used to initially and quickly enlarge the cavity at the strata interface, while sodium hydroxide and/or calcium hydroxide may be added to the production solvent in a later exploitation phase in order to promote for example the conversion of sodium bicarbonate to carbonate, hence resulting in greater extraction of desired alkali values from the trona stratum.

The production solvent injected for dissolution may comprise at least a portion of the brine which is extracted to the surface.

For the dissolution step during production, the production solvent may be preheated to a predetermined temperature to increase the solubility of one or more desired solutes present in the mineral ore. The higher the production solvent temperature, the higher the rate of dissolution at and near the point of solvent injection.

The production solvent may be injected for mineral dissolution from the ground surface to the interface at a surface temperature at least 20° C. higher than the in situ temperature of the mineral stratum. Alternatively, the production solvent may be injected from the ground surface to the interface at a surface temperature which is near the ambient rock temperature (the in situ temperature) at the injection depth. The surface temperature of the production solvent may be within +/−5° C. or within +/−3° C. of the in situ temperature of the target block of evaporite stratum. The in situ temperature of a trona stratum is estimated to be about 30-36° C. (86-96.8° F.), preferably 31-35° C. (87.8-95° F.).

However, it may be envisioned under certain circumstances that the solvent be initially injected at a surface temperature lower than the native rock temperature and allowed to warm while in situ.

The temperatures of the injected production solvent can vary from 32° F. (0° C.) to 250° F. (121° C.), preferably up to 220° F. (104° C.). Other temperature ranges provided earlier for the lifting fluid are also suitable for the production solvent.

The production solvent temperature may be between 0° F. and 200° F. (17.7-104° C.), or between 104 and 176° F. (40-80° C.), or between 140 and 176° F. (60-80° C.), or between 100 and 150° F. (37.8-65.6° C.).

The flow of production solvent may depend on the size of the cavity, such as the length of its flow path inside the cavity, the desired time of contact with ore to dissolve the mineral from the free face, as well as the stage of cavity development whether it be nascent for ongoing formation or mature for ongoing production.

For example, the production solvent volumetric flow rate in well 30 may vary from about 1 to 50 barrels per minute (or from about 9.5 m³/hr to about 477 m³/hr); or from about 2.1 BBL/min to about 31.4 BBL/min (or from 20 m³/hr to 300 m³/hr). Previous flow rates ranges provided earlier for the lifting fluid are also suitable for the production solvent.

The production solvent temperature generally changes from its point of injection as it gets exposed to trona. When the production solvent temperature is higher than the in situ temperature of the mineral stratum, the brine loses some heat as it flows through the mined cavity until the brine gets extracted to the surface.

### Extraction Step

At least a portion of the brine resulting from trona dissolution may be extracted to the ground surface via an extraction well 45 (illustrated in FIGS. 1 and 2). This extracted portion of the brine may be pulled or pushed to the ground surface via a pump or by reducing at least some hydraulic pressure. The brine may be extracted by flowback (release of pressure) to permit drainage of the cavity.

In some embodiments, the brine resulting from mineral-impregnated solvent may be extracted in a batch mode in which fresh solvent is injected into the gap or cavity thereby <<pushing>> the brine out of the gap or cavity and up the extraction well 45.

The extraction step may be such to substantially empty the cavity out of brine.

At least a portion of the brine which is extracted to the surface may have a surface temperature lower than the surface temperature of the solvent at the time of injection. The surface temperature in the extracted brine may be at least 3° C. lower, or at least 5° C. lower, or at least 8° C. lower, or even at least 10° C. lower, than the surface temperature of the injected solvent.

However, it may be envisioned under certain circumstances that the solvent be initially injected at a surface temperature lower than the native rock temperature and allowed to warm while in situ. In this instance, at least a portion of the brine which is extracted to the surface may have a surface temperature higher than the surface temperature of the solvent at the time of injection.

It is envisioned that brine aliquots may be analyzed continuously or intermittently during dissolution for desired solute content as well as for contaminant levels to determine the extent of dissolution. For example, in the case of the trona solution mining, brine aliquots may be analyzed for TA content and contaminants content such as sodium chloride and/or sodium sulfate.

This collection of data may be used by the mine operator to decide when to stop exploitation of the mineral cavity altogether. For example, once the TA content reaches a targeted value, brine extraction may be initiated for a batch mode or less brine is recycled to the cavity. When rising contents in chloride or other contaminants are observed in successive brine aliquots over time in continuous mode or from successive exploitation batch operations of the same cavity, this observation may be used by the mine operator as an indication that the solvent is making contact with a contaminants-containing layer such as a halite band and that the solution-mined cavity is approaching the roof of the mineral stratum.

Trona dissolution may be carried out until the brine extracted to the surface contains a maximum allowable impurity content, such as more than 0.2 wt % NaCl, or more than 0.5 wt % NaCl, or more than 0.7 wt % NaCl, or more than 0.9 wt % NaCl, or even more than 1 wt % NaCl. Once the NaCl content reaches this maximum allowable contamination level, the mine operator may decide to stop exploitation of the mined-out mineral cavity.

### Recycle and Use of Brine

A portion of such extracted second brine may be processed for recovery of the sodium values while another portion may be re-injected into the cavity.

The extracted brine may be stored in a vessel above ground before it may be used to provide at least a portion of the production solvent in later exploitation phase and/or to make mineral-derived products.

The brine extracted to the surface may be recycled back underground to provide at least a portion of the production solvent which is used for solution mining exploitation.

The portion of the brine which is extracted to the surface may be sent at least in part to a processing plant in which one or more mineral-derived products may be manufactured.

In the case of trona mining, the mineral-derived product(s) may be soda ash, any hydrates of sodium carbonate (such as decahydrate), sodium bicarbonate, sodium sesquicarbonate, sodium sulfite, sodium hydroxide, and/or other derivatives.

For trona mining, when the brine has a TA content of at least 8% or even at least 15%, at least a portion of the extracted brine which is not recycled to the cavity may be processed to obtain at least one product derived from a brine comprising dissolved trona.

### Injection of Insoluble Matter

In some embodiments, injection of insoluble materials (such as tailings) may be carried out concurrently with the lifting fluid during the lithological displacement step and/or with the production solvent during at least one exploitation operation according to the present invention. The injection of insoluble materials may be periodic (or intermittent or continuous) or a one-time occurrence.

During the lifting step, the injection of insoluble materials may comprise: mixing a specified amount of insoluble material with the fluid and injecting the combined mixture directly into the interface to place the insoluble materials inside the formed gap. Deposits of insoluble materials (such as proppant) may be employed to maintain open the gap formed after lifting.

During the dissolution step, the injection of insoluble materials may comprise: mixing a specified amount of insoluble material with the solvent and injecting the combined mixture directly into the nascent or enlarged gap (cavity).

Such injection of insoluble materials may form islands of insoluble material that would shift the fluid/solvent flow to fresh mineral surface (e.g., trona) thus changing flow paths through damming effects and/or would form some support for any possibility of downward-moving cavity ceiling. In this manner, a support system of insoluble material may be constructed to halt the ceiling movement to a desired point while flow channels created by dissolution of the solute in the mineral region surrounding the insoluble material would allow for movement of the brine through this region of the mineral ore. Deposits of insoluble materials (such as tailings) may also be employed to block certain flow pathways, especially those which may short-circuit passing over (or bypass) fresh mineral ore, such as observed with the phenomenon of ‘channeling’. The deposits of insoluble materials may also act to form a barrier from the shale floor and contaminants potentially falling from the upper areas of the trona stratum, keeping the solvent from contamination by an overlying contaminant-containing layer.

For trona solution mining, the insoluble material in the injected solvent may include tailings. Tailings in trona processing represent a water-insoluble matter recovered after a mechanically-mined trona is dissolved (generally after being calcined) in a surface refinery. During the mechanical mining of a trona stratum, some portions of the underlying floor and overlying roof rock which contain oil shale, mudstone, and claystone, as well as interbebded material, get extracted concurrently with the trona. The resulting mechanically-mined trona feedstock which is sent to the surface refinery may range in purity from a low of 75 percent to a high of nearly 95 percent trona. The surface refinery dissolves this feedstock (generally after a calcination step) in water or an aqueous medium to recover alkali values, and the portion which is non-soluble, e.g., the oil shale, mudstone, claystone, and interbedded material, is referred to as ‘insols’ or ‘tailings’. After trona dissolution, the tailings are separated from the sodium carbonate-containing liquor by a solid/liquid separation system.

### Injection of a Blanket Medium

In some embodiments of the present invention, a blanket medium which may be in gaseous form (such as comprising air, CO₂, methane, nitrogen, or any suitable gas which is inert under mining conditions) or in a liquid form (which is less dense than the solvent and brine, for example, a hydrocarbon liquid such as diesel or gasoline or gas oil) may be injected into the mineral cavity. This blanket injection allows the cavity enlargement to be carried out under hydraulic pressure equal to or less than hydrostatic head pressure which is determined by the depth of the targeted evaporite stratum, as a blanket forms at the ceiling of the cavity. In this manner, the blanket protects the mineral ceiling from dissolving and forces the dissolution in the horizontal direction rather than vertical. The blanket may serve to separate solvent from contaminated material in the cavity ceiling during the final stages of mineral extraction. This technique is particularly suitable for a mature mined-out cavity when the cavity contains sufficient mineral free-surfaces (e.g., fallen mineral rubble) other than the cavity mineral ceiling.

### In Situ Gas Release

For any or all embodiments of the present invention, some underground gas may be released from the underlying stratum or when part of the overburden susceptible to gravitational loading and crushing cracks and falls into the cavity, and gas may be released from the overlying stratum. When the underlying and/or overlying non-evaporite strata comprise oil shale, this released underground gas may contain methane. Indeed, in the case of trona mining, even though the trona itself contains very little carbonaceous material and therefore liberates very little methane, the underlying and overlying methane-bearing oil shale strata may liberate methane during lithological displacement and/or during solution mining. When such underground gas release occurs during lithological displacement, purges of the released gas may be performed periodically to remove the gas and relieve pressure so as to prevent methane gas buildup and/or to minimize safety concerns. It is recommended to stop injection downhole during such gas purge. Purge of released gas may be effected by passage to the surface via the well 30 used for injection. Alternatively, the purge of released gas may be effected by one or more secondary purge wells (not shown in figures). It is also conceived that much of the released gas may dissolve in the lifting fluid and/or production solvent and in which case dissolved gas may leave the liquid freely under low pressure conditions at the surface. This recovered gas is likely to have a high thermal energy content that may be used as a fuel for one or more processing operations (such as providing heat and/or steam for brine evaporation, crystallization, reaction, drying of product(s), . . . in a surface refinery) and/or for mining purposes.

### Recovery of Alkali Values and Products Obtained

In another aspect, the present invention relates to a manufacturing process for making one or more sodium-based products from an evaporite mineral stratum comprising a water-soluble mineral selected from the group consisting of trona, nahcolite, wegscheiderite, and combinations thereof, said process comprising:
carrying out the method of solution mining of the evaporite stratum according to any of the various aspects/embodiments of the present invention to obtain a brine comprising sodium carbonate and/or bicarbonate by dissolution of the mineral free surface by a solvent, and
passing at least a portion of said brine through one or more units selected from the group consisting a crystallizer, a reactor, and an electrodialysis unit, to form at least one sodium-based product.

In trona solution mining, the brine extracted to the surface may be used to recover alkali values.

Examples of suitable recovery of sodium values such as soda ash, sodium sesquicarbonate, sodium carbonate decahydrate, sodium bicarbonate, and/or any other sodium-based chemicals from a solution-mined brine can be found in the disclosures of U.S. Pat. No. 3,119,655 by Frint et al; U.S. Pat. No. 3,050,290 by Caldwell et al; U.S. Pat. No. 3,361,540 by Peverley et al; U.S. Pat. No. 5,262,134 by Frint et al.; and U.S. Pat. No. 7,507,388 by Ceylan et al., and these disclosures are thus incorporated by reference in the present application.

Another example of recovery of sodium values is the production of sodium hydroxide from a solution-mined brine. U.S. Pat. No. 4,652,054 to Copenhafer et al. discloses a solution mining process of a subterranean trona ore deposit with electrodialytically-prepared aqueous sodium hydroxide in a three zone cell in which soda ash is recovered from the withdrawn mining solution. U.S. Pat. No. 4,498,706 to Ilardi et al. discloses the use of electrodialysis unit co-products, hydrogen chloride and sodium hydroxide, as separate aqueous solvents in an integrated solution mining process for recovering soda ash. The electrodialytically-produced aqueous sodium hydroxide is utilized as the primary solution mining solvent and the co-produced aqueous hydrogen chloride is used to solution-mine NaCl-contaminated ore deposits to recover a brine feed for the electrodialysis unit operation. These patents are hereby incorporated by reference for their teachings concerning solution mining with an aqueous solution of an alkali, such as sodium hydroxide and concerning the making of a sodium hydroxide-containing aqueous solvent via electrodialysis.

The sodium-based products may be sodium sesquicarbonate, sodium carbonate monohydrate, sodium carbonate decahydrate, sodium carbonate heptahydrate, anhydrous sodium carbonate, sodium bicarbonate, sodium sulfite, sodium bisulfite, sodium hydroxide, and/or other derivatives.

The process may comprise: passing at least a portion of the brine comprising sodium carbonate and/or bicarbonate:
through a sodium sesquicarbonate crystallizer under crystallization promoting conditions to form sodium sesquicarbonate crystals;
through a sodium carbonate monohydrate crystallizer under crystallization promoting conditions to form sodium carbonate monohydrate crystals;
through a sodium carbonate crystallizer under crystallization promoting conditions to form anhydrous sodium carbonate crystals;
through a sodium carbonate hydrate crystallizer under crystallization promoting conditions to form crystals of sodium carbonate decahydrate or heptahydrate;
to a sodium sulfite plant where sodium carbonate is reacted with sulfur dioxide to form a sodium sulfite-containing stream which is fed through a sodium sulfite crystallizer under crystallization promoting conditions suitable to form sodium sulfite crystals; and/or
through a sodium bicarbonate reactor/crystallizer under crystallization promoting conditions comprising passing carbon dioxide to form sodium bicarbonate crystals.

In any embodiment of the present invention, the process may further include passing at least a portion of the brine through one or more electrodialysis units to form a sodium hydroxide-containing solution. This sodium hydroxide-containing solution may provide at least a part of the lifting fluid to be injected into the gap for the lifting step and/or may provide at least a part of the production solvent to be injected into the cavity for the dissolution step.

In any embodiment of the present invention, the process may further comprise pre-treating and/or enriching with a solid mineral and/or purifying (impurities removal) the extracted brine before making such product.

The present invention further relates to a sodium-based product obtained by the manufacturing process according to the present invention, said product being selected from the group consisting of sodium sesquicarbonate, sodium carbonate monohydrate, sodium carbonate decahydrate, sodium carbonate heptahydrate, anhydrous sodium carbonate, sodium bicarbonate, sodium sulfite, sodium bisulfite, sodium hydroxide, and other derivatives.

### Pre-Treatment of Brine Before Use

In some embodiments, the process may further comprise pre-treating at least one portion of a brine comprising sodium bicarbonate which is extracted from the underground.

The process may comprise pre-treating a portion of the extracted brine when such brine comprises sodium bicarbonate (preferably more than 3.5 wt %) before it is used to recover alkali values. The pre-treating may be carried out on at least a part of the extracted brine prior to being passed to an electrodialysis unit, a crystallizer, and/or a reactor.

The process may comprise pre-treating a portion of the extracted brine when such brine comprises sodium bicarbonate (preferably more than 3.5 wt %) before it is recycled to the cavity for further mineral dissolution.

The pre-treating in these instances may convert some of the sodium bicarbonate to sodium carbonate to achieve a sodium bicarbonate concentration in the pretreated brine below 3.5% by weight, preferably below 2% by weight, more preferably below 1% by weight, before being further subjected to a crystallization step or before being recycled at least in part to the cavity. The pretreatment of the brine may comprise contacting at least a portion of said brine with steam, and/or the pretreatment of the brine may comprise reacting the sodium bicarbonate in the brine with sodium hydroxide or another base such as calcium hydroxide.

The pre-treating may additionally or alternatively include adjusting the temperature and/or pressure of at least a portion of the extracted brine before recovering alkali values therefrom and/or before recycling into the cavity.

Forming Enriched Brine with Solid Mineral

In some embodiments, the process may further comprise adding solid mineral (such as mechanically-mined solid virgin trona or calcined trona) to at least a portion of the extracted brine which is not recycled to the cavity prior to being passed to a process unit (such as crystallizer and/or reactor) to make one or more valuable mineral-derived products (e.g., sodium-based products). The addition of solid mineral to the solution-mined brine may be carried out on at least a part of the brine after but preferably prior to the pre-treatment step as described earlier.

For brines obtained from solution mining of trona, the process may include, after extracting at least a portion of the brine to the surface, at least one of the following steps:
adding solid virgin trona and/or calcined trona to the extracted brine portion to increase the content in total sodium carbonate and to form an enriched brine containing at least 20% by weight of sodium carbonate;
optionally, pre-treating such enriched brine; and
recovering at least one alkali value, for example passing such enriched brine to an electrodialysis unit, a crystallizer, and/or a reactor in which at least one sodium-based product is produced.

### Removal of Impurities

In some embodiments, the process may further comprise removing at least a portion of undesirable solutes from at least a portion of the brine which is used to recover valuable products (such as alkali values) to purify the brine prior to being passed to a process unit (such as electrodialysis unit, crystallizer and/or reactor). Such removal may include removal of water-soluble and/or colloidal organics for example via carbon adsorption and/or filtration.

In embodiments for trona solution mining, the process may further comprise removing insoluble material from at least a portion of the brine which is used to recover alkali values, as some of the insoluble material may have precipitated once the brine is extracted to the surface and/or may have been carried from underground to above ground. Such removal may include sedimentation and/or filtration prior to being passed to a crystallizer and/or reactor to make sodium values.

This disclosure of all patent applications, and publications cited herein are hereby incorporated by reference, to the extent that they provide exemplary, procedural or other details supplementary to those set forth herein.

Should the disclosure of any of the patents, patent applications, and publications that are incorporated herein by reference conflict with the present specification to the extent that it might render a term unclear, the present specification shall take precedence.

Accordingly, the scope of protection is not limited by the description set out above, but is only limited by the claims which follow, that scope including all equivalents of the subject matter of the claims.

Each and every claim is incorporated into the specification as an embodiment of the present invention. Thus, the claims are a further description and are an addition to the preferred embodiments of the present invention.

While preferred embodiments of this invention have been shown and described, modifications thereof can be made by one skilled in the art without departing from the spirit or teaching of this invention. The embodiments described herein are exemplary only and are not limiting. Many variations and modifications of systems, methods, and processes are possible and are within the scope of the invention.

What we claimed is:

1. In an underground formation containing an evaporite mineral stratum comprising a mineral selected from the group consisting of trona, nahcolite, wegscheiderite, shortite, northupite, pirssonite, dawsonite, sylvite, carnalite, halite, and combinations thereof, said mineral stratum lying immediately above a non-evaporite stratum of a different composition, said formation comprising a defined weak parting interface between the two strata and above which is defined an overburden up to the ground surface,
a method for solution mining of said evaporite stratum, comprising a lithological displacement of the evaporite mineral stratum, wherein a fluid is injected at the parting interface to lift the evaporite stratum at a lifting hydraulic pressure greater than the overburden pressure, thereby forming a gap at the interface and creating a mineral free-surface, said lifting hydraulic pressure applied being characterized by a fracture gradient between 0.9 psi/ft (20.4 kPa/m) and 1.5 psi/ft (34 kPa/m);
wherein the fluid is injected in a directionally drilled well which is cemented and cased;
wherein said directionally drilled well comprises at least one horizontal borehole section comprising an in situ injection zone being in fluid communication with the strata interface; and
wherein the fluid injected through the well exits through the in situ injection zone of the horizontal borehole section, thereby lifting the overlying evaporite stratum at the interface so that the gap created at the interface is an extension of the horizontal borehole section.

2. (canceled)

3. The method according to claim 1, wherein the lifting hydraulic pressure is from 0.01% to 50% greater than the overburden pressure at the depth of the interface.

4. The method according to claim 1, wherein the injected fluid is a slurry comprising particles suspended in water or an aqueous solution.

5. The method according to claim 4, wherein the particles in the fluid comprise tailings used as proppant.

6. The method according to claim 1, wherein the injected fluid is a solvent suitable for dissolving the mineral.

7. The method according to claim 6, wherein the injected fluid comprises an unsaturated aqueous solution comprising sodium carbonate, sodium bicarbonate, sodium hydroxide, calcium hydroxide, or combinations thereof.

8. The method according to claim 6, wherein the injected fluid comprises an aqueous alkaline solution.

9. The method according to claim 1, wherein the parting interface is horizontal or near-horizontal with a dip of 5 degrees or less.

10. The method according to claim 1, wherein the fluid injection is carried out via a vertical or directionally drilled well which comprises an in situ injection zone which is in fluid communication with the parting strata interface.

11. The method according to claim 10, wherein the fluid injection is carried out via a vertical well which is drilled from the ground surface past the depth of the interface, and wherein the vertical well is cased and cemented through its entire length, but comprises an in situ injection zone being in fluid communication with the strata interface, said in situ injection zone of said vertical well comprising a downhole end opening and/or casing perforations.

12. (canceled)

13. The method according to claim 1, wherein the in situ injection zone of the horizontal borehole section comprises at least one casing opening selected from the group consisting of a downhole end opening of said horizontal borehole section, one or more casing perforations of said horizontal borehole section, and combinations thereof.

14. The method according to claim 1, wherein the evaporite mineral stratum comprises a water-soluble mineral selected from the group consisting of trona, nahcolite, wegscheiderite, and combinations thereof.

15. The method according to claim 1, wherein the evaporite mineral stratum comprises trona; and wherein the underlying stratum comprises oil shale.

16. The method according to claim 1, wherein the interface between the two strata is at a shallow depth of 3,000 ft (914 m) or less.

17. The method according to claim 1, further comprising dissolving the mineral from the created mineral free-surface into a solvent to form a brine, and to enlarge the gap to form a mineral cavity.

18. The method according to claim 17, wherein the mineral cavity comprises a ceiling, and wherein the mineral dissolution is carried out at a hydraulic pressure equal to or less than hydrostatic head pressure in the cavity when a layer of insolubles at the bottom of the cavity provides support for the cavity ceiling.

19. The method according to claim 17, wherein the mineral cavity comprises a ceiling, and wherein the method further comprises injecting a blanket medium so as to prevent dissolution of mineral from the ceiling of the cavity.

20. A manufacturing process for making one or more sodium-based products from an evaporite mineral stratum comprises a water-soluble mineral selected from the group consisting of trona, nahcolite, wegscheiderite, and combinations thereof, which comprises:
carrying out the method for solution mining of said evaporite stratum according to claim 1 to obtain a brine comprising sodium carbonate and/or bicarbonate by dissolution of the mineral free surface by a solvent, and
passing at least a portion of said brine through one or more units selected from the group consisting a crystallizer, a reactor, and an electrodialysis unit, to form at least one sodium-based product.

21. The method according to claim 13, wherein the in situ injection zone of the horizontal borehole section comprises one or more casing perforations of said horizontal borehole section, and
wherein the casing perforations are either:
on two generatrices of the horizontal borehole section which are aligned with the parting interface to laterally inject the fluid from both sidewalls of the horizontal borehole section; or
on one generatrix of the horizontal borehole section which is aligned with the parting interface to laterally inject the fluid from only one sidewall of the horizontal borehole section.

22. In an underground formation containing an evaporite mineral stratum comprising a mineral selected from the group consisting of trona, nahcolite, wegscheiderite, and combinations thereof, said mineral stratum lying immediately above a non-evaporite stratum of a different composition, said formation comprising a defined weak parting interface between the two strata and above which is defined an overburden up to the ground surface,
a method for solution mining of said evaporite mineral stratum, comprising a lithological displacement of the evaporite mineral stratum, wherein a fluid is injected at the parting interface to lift the evaporite mineral stratum at a lifting hydraulic pressure greater than the overburden pressure, thereby forming a gap at the interface and creating a mineral free-surface,
wherein the fluid injected at the lifting hydraulic pressure is a slurry comprising particles suspended in water or an aqueous solution; and
wherein the particles in the fluid injected at the lifting hydraulic pressure comprise tailings used as proppant, said tailings being obtained during refining of mechanically-mined trona.
